(19) United States
(12) Patent Application Publication
(10) Pub. No.: US 2021/0009270 A1
(43) Pub. Date: Jan. 14, 2021

(54) METHODS AND SYSTEM FOR COMPOSING AND CAPTURING IMAGES

(71) Applicant: SZ DJI TECHNOLOGY CO., LTD., Shenzhen (CN)

(72) Inventors: Wei CHEN, Shenzhen (CN); Chaunchuan DOU, Shenzhen (CN)

(73) Assignee: SZ DJI TECHNOLOGY CO., LTD., Shenzhen (CN)

(21) Appl. No.: 17/060,543

(22) Filed: Oct. 1, 2020

Related U.S. Application Data
(63) Continuation of application No. PCT/CN2018/081920, filed on Apr. 4, 2018.

(51) Int. Cl. B64C 39/02; G05D 1/08; G05D 1/00; H04N 5/235

(52) U.S. Cl. CPC B64C 39/024; G05D 1/0816; B64C 2201/146; H04N 5/2353; B64C 2201/127; G05D 1/0016

(57) ABSTRACT

The systems, devices, and methods are provided for image capture using UAVs. An image can be obtained from an imaging device carried by an unmanned aerial vehicle (UAV), The imaging device may be coupled to the UAV via a carrier that permits the imaging device to move relative to the UAV with respect to one or more axes. One or more composition metrics can be obtained. A composition of the image can be evaluated using the one or more composition metrics. The UAV and/or the carrier can be controlled based at least in part on the evaluation.

### BACKGROUND

Unmanned aerial vehicles (UAVs) have greatly expanded the reach of modern photography. However, capturing aesthetically-pleasing photographs with great composition remains challenging especially for aerial photography. An aerial photographer typically need be both a skilled UAV operator and an experienced photographer, in order to concurrently maneuver the UAV or angle of the imaging device and control the shutter of the camera to achieve the right composition. Existing approaches that provide composition assistance leave much to be desired. A common approach is to process a digital image after it has been taken (e.g., cropping) to change to change the composition. However, such post-image-processing can reduce the image resolution of the resulting photograph. Another approach is to provide guidance information to a user to help the user capture photographs with good composition. However, this approach still requires a user to control the shutter.

### SUMMARY

According to embodiments, a computer-implemented method is provided. The method comprises obtaining an image from an imaging device carried by an unmanned aerial vehicle (UAV), the imaging device being coupled to the UAV via a carrier that permits the imaging device to move relative to the UAV with respect to one or more axes; obtaining one or more composition metrics; evaluating a composition of the image using the one or more composition metrics; and controlling the UAV and/or the carrier based at least in part on the evaluation.

According to embodiments, a system is provided. The system comprises a memory that stores one or more computer-executable instructions; and one or more processors configured to access the memory and execute the computer-executable instructions to perform a method comprising: obtaining an image from an imaging device carried by an unmanned aerial vehicle (UAV), the imaging device being coupled to the UAV via a carrier that permits the imaging device to move relative to the UAV with respect to one or more axes; obtaining one or more composition metrics; evaluating a composition of the image using the one or more composition metrics; and controlling the UAV and/or the carrier based at least in part on the evaluation.

According to embodiments, a computer-implemented method is provided. The method comprises obtaining a first image from an imaging device carried by an unmanned aerial vehicle (UAV); obtaining one or more composition metrics; evaluating a composition of the first image using the one or more composition metrics; and controlling a shutter of the imaging device to capture a second image based at least in part on the evaluation.

According to embodiments, one or more non-transitory computer-readable storage media is provided, storing computer-executable instructions that, when executed by one or more processors, configure the one or more processors to perform a method comprising obtaining a first image from an imaging device carried by an unmanned aerial vehicle (UAV); obtaining one or more composition metrics; evaluating a composition of the first image using the one or more composition metrics; and controlling a shutter of the imaging device to capture a second image based at least in part on the evaluation.

According to embodiments, a computer-implemented method is provided. The method comprises obtaining an image from an imaging device carried by an unmanned aerial vehicle (UAV), the imaging device being coupled to the UAV via a carrier that permits the imaging device to move relative to the UAV with respect to one or more axes; selecting a composition metric for the image from a plurality of composition metrics; and controlling the UAV and/or the carrier based at least in part on the selected composition metric.

According to embodiments, a system is provided. The system comprises a memory that stores one or more computer-executable instructions; and one or more processors configured to access the memory and execute the computer-executable instructions to perform a method comprising obtaining an image from an imaging device carried by an unmanned aerial vehicle (UAV), the imaging device being coupled to the UAV via a carrier that permits the imaging device to move relative to the UAV with respect to one or more axes; selecting a composition metric for the image from a plurality of composition metrics; and controlling the UAV and/or the carrier based at least in part on the selected composition metric.

It shall be understood that different aspects of the invention can be appreciated individually, collectively, or in combination with each other. Various aspects of the invention described herein may be applied to any of the particular applications set forth below or data communication between any other types of movable and/or stationary objects.

Other objects and features of the present invention will become apparent by a review of the specification, claims, and appended figures.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an exemplary environment for implementing image composition optimization, in accordance with embodiments;

FIG. 2 illustrates exemplary components in a system for implementing composition optimization, in accordance with embodiments;

FIG. 3 illustrates an exemplary process for composition evaluation based on rules, in accordance with embodiments;

FIG. 4 illustrates an exemplary process for composition evaluation based on templates, in accordance with embodiments;

FIG. 5 illustrates exemplary user interface(s) for configuring composition rules and/or templates, in accordance with embodiments;

FIG. 6 illustrates exemplary user interface(s) for configuring composition rules and/or templates, in accordance with embodiments;

FIG. 7 illustrates an exemplary method for maintaining an expected position of a target within an image, in accordance with embodiments;

FIG. 8 illustrates an exemplary method for maintaining an expected size of a target, in accordance with embodiments;

FIG. 9 illustrates an exemplary feedback control system for adjusting movement of the imaging device, in accordance with some embodiments;

FIG. 10 illustrates an exemplary process for image capture, in accordance with embodiments;

FIG. 11 illustrates an exemplary process for image capture, in accordance with embodiments;

FIG. 12 illustrates a movable object including a carrier and a payload, in accordance with embodiments; and

FIG. 13 is a schematic illustration by way of block diagram of a system for controlling a movable object, in accordance with embodiments.

### DETAILED DESCRIPTION

The systems, devices, and methods are provided for image capture using UAVs that address some or all of the above-mentioned problems. In some embodiments, one or more preview images can be obtained from an imaging device carried by a UAV. The imaging device may or may not be coupled to the UAV via a carrier. The carrier may or may not permit the imaging device to move with respect to the UAV. The preview images can be evaluated with respect to one or more composition metrics such as composition rules or composition templates. In some embodiments, the composition metrics may be used to determine a composition score that indicates compliance of image composition with the composition metrics. In some other embodiments, an optimal composition metric may be selected from a plurality of composition metrics. The selection may be based on metric scores associated with the composition metrics. The metric score may indicate suitability of the composition metric for the image. The selected composition metric may be determined to be the most suitable for the current image based on contextual information of the image (e.g., scene or environment).

Based on the evaluation, it may be determined further adjustment is needed to achieve the optimal composition as defined by the composition metrics or by the selected composition metric. If further adjustment is needed, then control signals can be generated for automatically controlling the UAV and/or a carrier of the imaging device so as to achieve the optimal composition. If no further adjustment is needed, a shutter of the imaging device may be automatically controlled to capture one or more non-preview images (photographs).

The techniques described herein provide several advantages over existing techniques, some of which are discussed below. The disclosed techniques can provide automated control of the UAV and/or the carrier to position the imaging device at the right position and/or angle, so as to achieve the optimal composition. This can be done without user intervention, thereby relieving the user the task of manual control of the UAV and/or the carrier, and enhancing the speed and accuracy of control. Furthermore, unlike existing post-image-processing techniques, the image resolution is not sacrificed. The disclosed techniques can also provide automated shutter control to capture photographs when the composition is optimal. The user is relieved of the task of determining when to release the shutter. In some embodiments, the selection and the evaluation of the composition metrics can be automated without user intervention, thereby relieving the user the task of memorizing and applying different composition rules. Accordingly, the disclosed techniques can greatly lower the user requirement for aerial photography, enabling a layperson not experienced in photographic composition to easily compose and capture aesthetically-pleasing images using a UAV. By removing human errors, the disclosed techniques can also increase the efficiency and accuracy for achieving optimal composition in aerial photography.

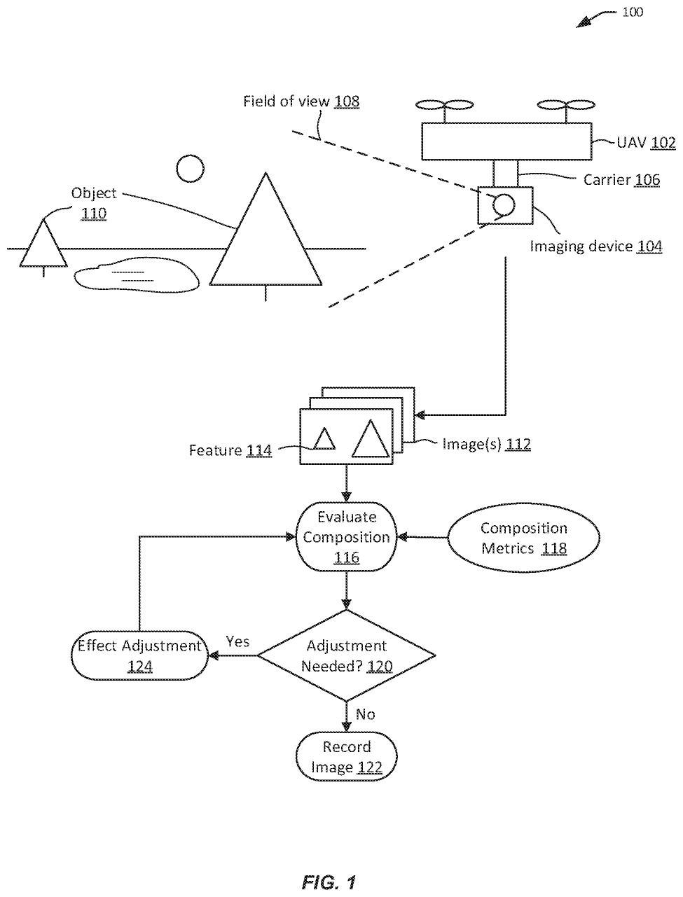

FIG. 1 illustrates an exemplary environment 100 for implementing image composition optimization, in accordance with embodiments. In this environment, a UAV 102 carrying an imaging device 104 can be controlled to capture images 112, so as to optimize image composition.

The UAV 102 can be configured to carry the imaging device 104 via a carrier 106. The carrier 106 may or may not permit the imaging device 104 to move (e.g., translationally or rotationally) relative to the UAV.

The imaging device 104 can be configured to capture images of objects 110 in its field of view (FOV) 108. The imaging device 104 can be configured to capture one or more images 112. For instance, the imaging device 104 may be configured to continuously capture a series of preview images (also referred to as “live view images”). Each image 112 may include features 114 corresponding to the one or more objects 110. The spatial arrangement of elements or features of the image is referred to as the image composition. The image composition for one or more preview image 112 may be evaluated to determine whether to capture a photograph (e.g., by controlling a mechanical or electronic shutter of the imaging device 104) or to adjust the UAV, carrier, and/or imaging device.

An exemplary process for image evaluation is illustrated. At block 116, a composition of one or more images 112 (e.g., preview images) may be evaluated. The evaluation of the image composition may be based at least in part on one or more composition metrics 118. A composition metric can include a composition standard against which an image can be measured. A composition metric can include, without limitation, a composition templates or a composition rule. Such composition metrics may be pre-configured or dynamically selected. In some embodiments, a preview image may be analyzed to identify certain features such as salient regions and/or prominent lines. The characteristics or information about such features and their spatial relationship thereof may be compared with the composition templates or composition rules. For instance, information for prominent regions can include the number of such prominent regions, the size of a bounding box around each prominent region, a position (e.g., pixel coordinates) of each prominent region in the image, and the like. Information for prominent lines can include a number of such lines, and parameters of respective linear equations for the lines under an image coordinate system. The composition metrics 118 may define an ideal or target composition that is deemed aesthetically-pleasing or otherwise desirable. For example, composition rules may include the rule of the thirds, the diagonal rule, and the like. An image composition that substantially conforms with the composition metrics is deemed to match the target composition and hence satisfactory. In some embodiments, a composition score may be determined based on the composition metrics and a threshold score may be compared with the composition score to determine whether the image composition matches the composition metrics.

At block 120, it may be determined whether to further adjustment is needed based on the evaluation result. The adjustment may be related to a spatial disposition (e.g., position, orientation) of the imaging device or to a configuration or setting of the imaging device (e.g., zoom, focal length). The adjustment may be necessary to effect a change in the FOV of the imaging device, and hence a change in composition in a subsequently captured image.

If it is determined at block 120 that an adjustment is needed, for example, because the current image composition does not match the composition templates or rules, then at block 124, the adjustment is implemented. In some embodiments, a deviation between a current image composition and a target composition is determined, and control signals are generated to reduce the deviation. The control signals can be configured to effect a movement of the UAV 102 and/or the carrier 106 of the imaging device 104, so as to change a spatial disposition (e.g., position and/or orientation) of the imaging device. Alternatively or additionally, the control signals can be configured to change a parameter or a setting of the imaging device (e.g., zoom level, aperture, focal length). The adjustment may continue until the desired composition is achieved. In some embodiments, a feedback control loop may be used to achieve the desired adjustment.

If it is determined at block 120 that an adjustment is not needed, for example, because the current image composition substantially matches the composition templates or rules, then at block 122, the imaging device 104 may be controlled to record an image (e.g., capturing a photograph). For example, one or more control signals may be generated for controlling a shutter of the imaging device 104 (e.g., a mechanical shutter or an electrical shutter), such that an image is captured. The image thus recorded may be referred to as a recorded image.

Aspects of the illustrated process may be implemented by processors onboard the UAV (e.g., inside and/or outside the imaging device), by processors offboard the UAV (e.g., on a remote terminal), or by a combination of both. For instance, in some embodiments, the preview images 112 may be transmitted to the remote terminal for the evaluation. In an example, an application (app) running on the remote terminal may be configured to perform the evaluation. In some other embodiments, evaluation of the preview images may be performed by a processor inside the imaging device or otherwise onboard the UAV. In some embodiments, control signals for adjusting or otherwise controlling the UAV/carrier/imaging device may be generated offboard the UAV and transmitted to the UAV/carrier/imaging device. In other embodiments, the control signals may be generated onboard the UAV.

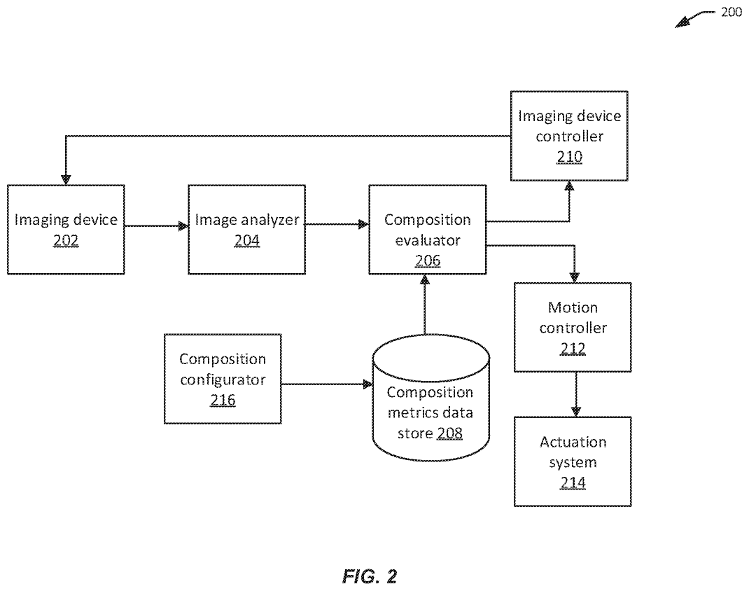

FIG. 2 illustrates exemplary components in a system 200 for implementing composition optimization, in accordance with embodiments. These components can be implemented by one or more processors configured to implement executable instructions stored in non-transitory storage media. The one or more processors can include ARM processors, field-programmable gate arrays (FPGAs), application-specific integrated circuits (ASICs), central processing units (CPUs), graphics processing units (GPUs), and the like. In some embodiments, some or all of the components may be implemented using hardware acceleration techniques. The system 200 can comprise an imaging device 202, an image analyzer 204, a composition evaluator 206, an image device controller 210, a motion controller 212, an actuation system 214, a composition configurator 216, and a composition metrics data store 208. In various embodiments, the components discussed herein may be implemented on a UAV, on a payload carried by the UAV, and/or on a remote terminal or system.

The imaging device 202 can be configure to capture one or more images. The imaging device can be configured to capture one or more preview images and/or one or more recorded images. The preview images may be captured automatically at a higher frequency or on a continuous basis when the imaging device is in in a preview or live view mode. In some embodiments, the preview images may include image frames in a video. The preview images may be used to evaluate or determine a composition or other settings associated with the images and/or the imaging device. The recorded images, on the other hand, may be still images captured via release of a shutter of the imaging device. The shutter may be mechanical or electronic. The recorded images may be captured based on the evaluation of the preview images. The recorded images may be captured in an image capture mode.

The imaging device can include one or more optical assemblies and one or more image sensors. Each optical assembly may comprise one or more lenses. The imaging device can include one or more mechanical and/or electronic shutters. In various embodiments, the preview images and the recorded images may be generated using the same image sensor or different image sensors. The preview images and the recorded image may be generated using the same optical assembly or different optical assemblies. The preview images and the recorded images may be captured using the same or different mechanical and/or electronic shutters.

In an example, the preview images and the recorded images are generated using the same optical assembly and the same image sensor. In another example, the preview images and the recorded images are generated by the same optical assembly, but different image sensors. In another example, the preview images and the recorded images are generated by different optical assemblies but the same image sensor. In another example, the preview images and the recorded images are generated by different optical assemblies and different image sensors.

In some embodiments, the preview images and the recorded images may be generated using one or more mechanical shutters. The preview images and the recorded images may be generated using one or more electronic shutters. The preview images and the recorded images may be generated using the same or different electronic shutters. The preview images and the recorded images may be generated using the same or different mechanical shutters. In some embodiments, the review images are generated using one or more electronic shutters and the recorded images are generated using one or more mechanical shutters. In some other embodiments, the review images are generated using one or more mechanical shutters and the recorded images are generated using one or more electronic shutters.

In some embodiments, the imaging device 202 can be configured to automatically adjust device settings and/or process image data acquired by the image sensor(s). Such tasks include, but are not limited to, autofocus, automatic exposure adjustment, automatic color balancing, image pipeline processing (e.g., image sensor corrections, noise reduction, image scaling, gama correction, colorspace conversion, chroma subsampling, framerate conversion, image compression/encoding, data transmission), and the like. In some embodiments, some or all of the above image processing may be performed by the image analyzer 204.

Image data of images (e.g., preview images) generated by the imaging device 202 can be provided to the image analyzer 204. The image analyzer 204 can be configured to detect and extract features from the image data, so as to facilitate composition evaluation described below. For example, the image analyzer 204 may be configured detect features salient or prominent lines, blobs or regions, edges, corners or points of interests, and the like. In some embodiments, image segmentation techniques may be used to partition an image into multiple segments, so as to facilitate image analysis. Information associated with the extracted features such as size, position, intensity, color, texture, and the like may be determined as part of the image analysis. For instance, information for prominent regions can include the number of such prominent regions, the size of a bounding box around each prominent region, a position (e.g., pixel coordinates) of each prominent region in the image, and the like. Information for prominent lines can include a number of such lines, and linear equation parameters under the image coordinate system.

In some embodiments, the image analyzer 204 may be configured to obtain contextual information with respect to the images. For example, an image may be analyzed to determine whether it shows a single person or object (e.g., a portrait), a group people (e.g., a group selfie), a landscape (e.g., manmade or natural landscape), and the like. As another example, a time, a location, or an imaging device setting associated with the image may be obtained. As yet another example, environmental information such as temperature, humidity, wind speed, density of surrounding objects, and the like may be obtained. Such contextual information can be obtained by analyzing the image data itself, e.g., by analyzing the characteristics of the features (e.g., shape, size, intensity, texture) and their relationship with each other. Or, the contextual information may be determined based on sensing data obtained from sensors associated with the imaging device, the carrier, and/or the UAV. Examples of such sensors include position sensors (e.g., GPS sensor), magnetometer, motion sensors (e.g., gyros/accelerometers), temperature sensors, pressure sensor (e.g., barometer), proximity sensor (e.g., ultrasound, laser, lidar), vision sensor, and the like. In some embodiments, contextual information may include historical information, such as contextual information of previously captured images including previous settings of the imaging devices. In some embodiments, machine learning algorithms may be applied in analyzing the images. For example, people or objects in the images may be identified using facial recognition or pattern recognition techniques and the identity of the people or objects may be provided as part of the contextual information of the images. The contextual information discussed herein may be subsequently used by the composition evaluator 206, the motion controller 212, and/or the imaging device controller 210.

The composition evaluator 206 can be configured to evaluate a composition of an image (e.g., a preview image) to determine whether the composition is satisfactory. The evaluation of the composition can be based on the analysis of the image analyzer 204 and one or more composition metrics (e.g., composition rules and/or composition templates). For example, a spatial arrangement of the features extracted by the image analyzer 204 can be evaluated with respect to a set of composition rules or with respect to a composition template to determine a composition score. The composition score may be compared with a predetermined threshold score to determine whether the composition of the image complies with the set of rules. As another example, the extracted features of an image may be compared with features of a composition template to determine whether a composition of the image matches the target composition defined by the composition template.

In some embodiments, the evaluation can include determining a metric score for each of a set of composition metrics based on the image and selecting an optimal composition metric based on the metric scores. For instance, the composition metric with the highest metric score may be selected. Subsequently, the UAV/carrier/imaging device may be controlled according to the selected metric.

In some embodiments, the composition rules and/or templates used to evaluate a given image may be provided by default. In some other embodiments, a user may be allowed to select one or more composition rules/templates, for example, via a user interface on a remote terminal. In some other embodiments, the composition evaluation 206 can be configured to automatically select one or more composition metrics (e.g., composition rules and/or composition templates) from a plurality of composition metrics stored in a data store 208. The selection may be based at least in part on contextual information obtained by the image analyzer. For example, depending on whether the image is a portrait or a landscape, different set of composition rules/templates may be selected. Any combinations of the above approaches may be used in various embodiments.

In some embodiments, the composition evaluator 206 may be configured to evaluate the image against a plurality of composition metrics to derive a composition score associated with each composition metric. The composition metric with the highest composition score may be selected and the UAV and/or carrier may be controlled accordingly in order to achieve the selected composition metric.

Based on the evaluation result, the imaging device and/or a motion of the UAV and/or carrier may be controlled. In some embodiments, if the composition of the image is determined to be satisfactory, a shutter of imaging device (e.g., a mechanical shutter or an electronic shutter) may be controlled to capture a recorded image (e.g., taking a photograph). The shutter may be controlled or be part of the imaging device controller 210. The shutter may include a mechanical shutter or an electronic shutter. The recorded image may be stored in a memory unit onboard the UAV (e.g., in the imaging device or outside the imaging device), and/or transmitted to a remote terminal for display, processing, or storage. The images may be compressed or otherwise processed before being transmitted.

If the composition of the image is determined not to be satisfactory, then further adjustment may be needed before capturing a recorded image. In some embodiments, a deviation between the current composition of the image and a target composition defined by the composition template or composition rules may be determined. The deviation may comprise a deviation in size or position of one or more features. Based on the deviation, control signals may be generated for controlling an actuation system 214, so as to substantially reduce the deviation. The deviation determination and the control signal generation may be performed by the composition evaluator 206 and/or the motion controller 212. The actuation system 214 may include a propulsion system for the UAV (e.g., comprising one or more rotors) and/or an actuation assembly for the carrier (e.g., comprising one or more motors). For example, the control signals can be used to control a position, orientation, velocity, acceleration, and the like of the UAV and/or the carrier to which the imaging device is attached. The adjustment can result in a change to the FOV of the imaging device, which may change the resulting imaging composition of post-adjustment images. In some embodiments, the motion controller 212 may include a feedback controller for adjusting the state of the UAV and/or the carrier.

In some embodiments. settings of the imaging device can also be controlled to reduce the deviation between a current composition and a target composition. The control of the imaging device may be achieved by the imaging device controller 210. For instance, a zoom level of the imaging device may be controlled so as to resize a feature in the images. Other settings of the imaging device may also be adjusted including, but not limited to, aperture, shutter speed, focal length, exposure, white balance, camera mode, and the like. In various embodiments, the imaging device controller 210 may be an integral part of the imaging device (e.g., co-located with other components of the imaging device 202 in the same housing), or separate from other components of the imaging device.

In some embodiments, a composition configurator 216 can be provided for configuring composition metrics (e.g., composition rules and/or composition templates) that can be used to evaluate image composition. Configuration of the composition metrics can include creating, selecting, deleting, or modifying the composition metrics. The composition metrics thus configured may be applied by default to all images being evaluated. Or, the composition metrics may be applied specifically to different types of images. Or, the composition metrics may be applied specific to a particular image.

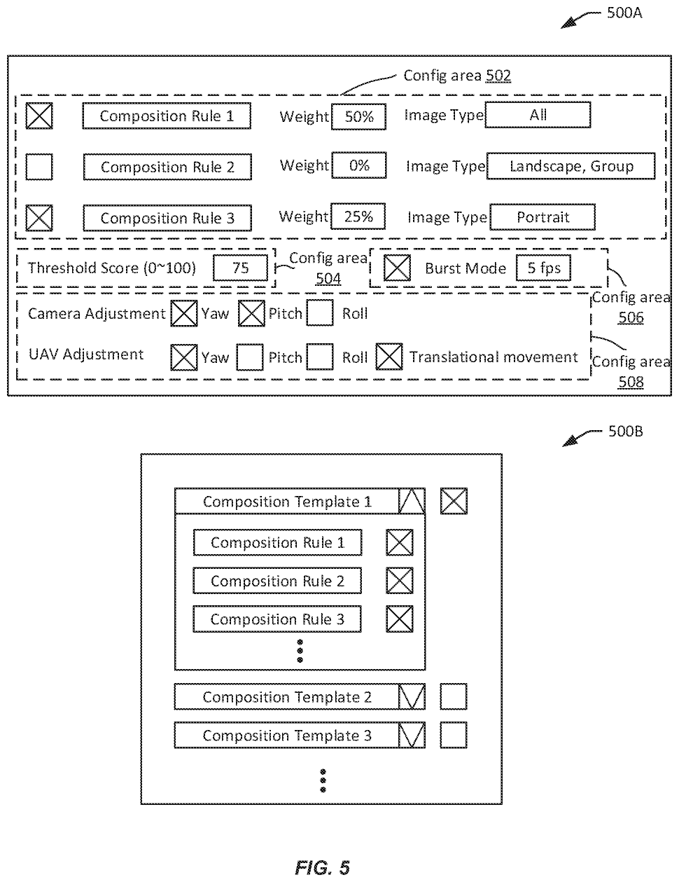

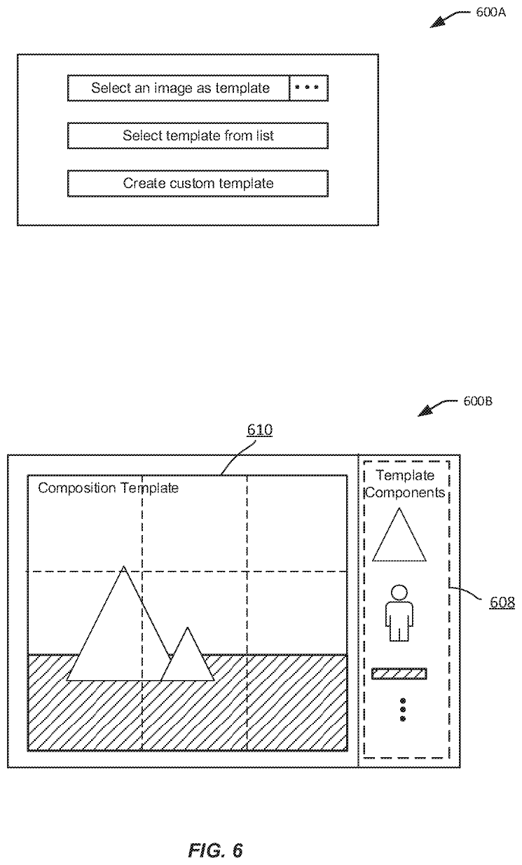

In some embodiments, the composition configurator 216 may comprise a user interface implemented by a remote terminal that is remote to the UAV. For example, the composition configurator 216 may be implemented by an application running on a mobile device. The user may use the composition configurator 216 to specify or modify general or specific composition metrics. FIGS. 5-6 illustrate some exemplary user interfaces that may be provided by the composition configurator 216.

In some embodiments, the configuration of the composition metrics may occur before the evaluation of image composition. For instance, the composition metrics may be configured before the UAV takes off, after UAV takes off but before the capturing of the preview images, or after the capturing of the preview images but before the composition evaluator 206 processes the images. In some other embodiments, the configuration of composition metrics may occur or as part of composition evaluation. For example, an image may be transmitted to a remote terminal, where a user may use the composition configurator 216 to select one or more composition metrics for evaluating the image. As another example, one or more composition metrics may be selected automatically (e.g., by the composition evaluator 206 based at least in part on contextual information). These automatically selected composition metrics may be presented to a remote user for approval and the remote user may be able to further change the selected composition metrics using the composition configurator 216. Information about user-configured or user-approved composition metrics may then be provided to the composition evaluator 206 for composition evaluation.

Data or files representing the composition metrics (e.g., composition rules and/or composition templates) may be stored in a data store 208. For instance, the composition metrics may be stored as in XML files. The data store 208 can comprise any suitable storage unit or device including a table, a file, a database, a drive, a volume, and the like. The data store 208 can be local to the UAV (e.g., a memory) or remote to the UAV (e.g., a memory on a remote terminal or a cloud-based server).

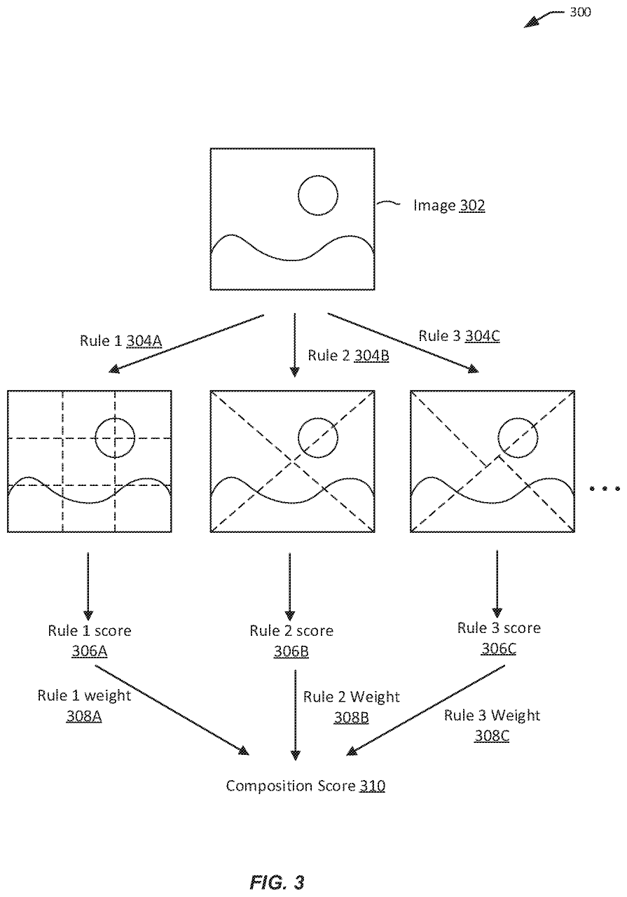

FIG. 3 illustrates an exemplary process 300 for composition evaluation based on composition rules, in accordance with embodiments. While the following discussion is provided with respect to composition rules, it is understood that the principles apply to any other composition metrics such as composition templates.

As illustrated, an image 302 may be analyzed according to a set of one or more composition rules, such as rule 1 304A, rule 2 304B, and rule 3 304C. The rules may be provided by default, selected automatically based on the image or contextual information thereof, and/or specified by a user. Exemplary composition rules can include, but not limited to, the rule of thirds, diagonal rule, the golden triangle rule, the horizontal/vertical rule, the limb rule, the simple background rule, the balance rule, and the like. For instance, the rule of thirds states that an image should be imagined as divided into nine equal parts by two equally spaced horizontal lines and two equally spaced vertical lines, and that important compositional elements should be placed along those lines or their intersections (e.g., as illustrated by the dotted lines for rule 1 304A). The diagonal rule states that prominent lines of the image should lie close to the diagonal lines (e.g., as illustrated by the dotted lines for rule 2 304B). The golden triangle rule states that the subject of an image should fill one or more of the triangles formed by the diagonal line and the two lines that connect the corners with the diagonal line and perpendicular to the diagonal line (e.g., as illustrated by the dotted lines for rule 3 304C). The horizontal/vertical rule states that prominent lines should be parallel to the horizontal or vertical edges of the frame. The limb rule states that a person's limbs or some other body parts should not appear cut off by the edge of the frame. The simple background rule states that simple background is better than cluttered background. The balance rule states that the visual “center of mass” of objects of interest (e.g., salient regions) should be near the center of the image.

Each composition rule may be applied to the current image composition to determine a composition score of the image that is specific to the rule (rule score). Applying a given composition rule to an image may comprise determining whether elements or features in the image (e.g., salient regions, prominent lines) are arranged according to the composition rule. For instance, the rule scores for rule 1 304A, rule 2 304B, and rule 3 304C are rule 1 score 306A, 306B, and 306C, respectively. The rule score associated with a given rule can indicate how well the image composition complies with the rule. A higher rule score may indicate a higher level of compliance or conformity. In alternative embodiments, a lower rule score may indicate a higher level of compliance or conformity.

An overall composition score 310 can be determined based on the rule scores. The composition score can indicate an overall aesthetic value of the image's composition with respect to the set of rules. In general, an image with a higher composition score may be deemed more aesthetically-pleasing than another image with a lower composition score. In alternative embodiments, an image with a lower composition score may be deemed more aesthetically-pleasing than another image with a higher composition score.

Various methods may be used to determine the composition score based on rule scores. In some embodiments, the composition score 310 may be a maximum value, a minimum value, a mean value or an average value of the rule scores. In some other embodiments, each of the rules and rule scores may be assigned a weight and the composition score may be calculated as a weighted average of the rule scores. The weight value associated with a given composition rule indicates an importance of the rule in the overall evaluation. For example, the weight values for rule 1 304A, rule 2 304B, and rule 3 304C are rule 1 weight 308A, 308B, and 308C, respectively. In some embodiments, the weight values associated with the rules may be determined based on the type of the image, a scene of the image, or other contextual information.

In some embodiments, the overall composition score may be compared with a predetermined threshold value to determine whether the composition of the image is satisfactory. For example, in an example, if the composition score is equal to or greater than the predetermined threshold value, then the image composition is determined to be satisfactory. In another example, the image composition may be determined to be satisfactory when the composition score is equal to or less than the predetermined threshold value. If the image composition is determined to be satisfactory, a shutter of the imaging device may be controlled so as to capture a recorded image (e.g., taking a picture). Otherwise, adjustments may be necessary to achieve the optimal composition. For instance, control signals may be generated for controlling an actuation system for the UAV and/or the carrier, so as to adjust a position and/or an orientation of the imaging device.

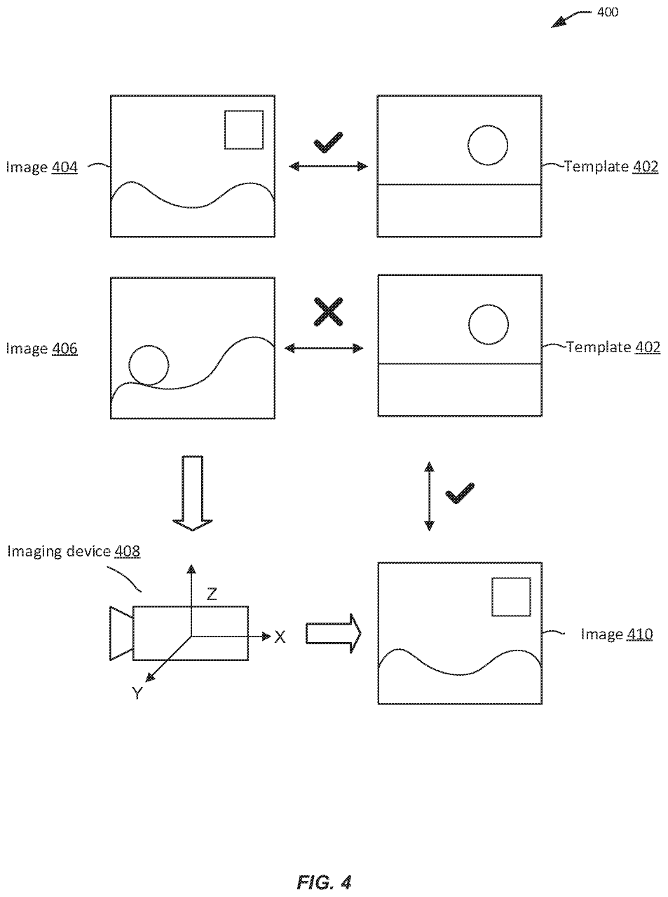

FIG. 4 illustrates an exemplary process 400 for composition evaluation based on composition templates, in accordance with embodiments.

As illustrated, one or more images 404, 406 may be compared with a composition template 402. The images 404, 406 may be preview images captured by an imaging device carried by a UAV, for example. The imaging device may or may not be coupled to the UAV via a carrier that permits movement of the imaging device relative to the UAV. The composition template 402 may specify a certain spatial arrangement of elements or features in an image. For instance, a composition template may specify that a first type of object (e.g., a person) should be positioned at an intersection of two one-third lines and that a second type of object (e.g., a horizon) should be aligned horizontally. The composition template to be used for evaluating a given image may be provided by default, selected automatically based on the image or contextual information thereof, and/or specified by a user.

In some embodiments, features of the image and features of the template may be matched to determine whether the spatial arrangement of the image features match the spatial arrangement of the template. The matching may comprise identifying a correspondence between features of the image and features of the template, for example, using object recognition and classification and image matching techniques. The matching between the features may not be exact, and feature with positional deviations within a predetermined threshold of error (e.g., 5 pixels, 10 pixels) may still be considered a match. For example, as illustrated in FIG. 4, image 404 and template 402 are considered a match because the positions of features in the image 404 substantially match the corresponding features in template 402, even though the features do not match exactly. On the other hand, the image 406 is determined not to match the template 402, because the corresponding features in the image 406 and the template 402 are not arranged in a similar fashion (e.g., the deviation between the features exceeds a predetermined threshold of error). In various embodiments, any suitable image matching or image registration techniques may be used. For instance, a transformation or motion vector between features of the image and features of the template may be determined or estimated. The transformation or motion vector may be compared with a threshold transformation or motion vector to determine whether the difference between the image and the template is small enough.

If the image 404 is determined to match the template 402, then a shutter may be controlled, so as to capture a recorded image. On the other hand, if the image 406 is determined not to match the template 402, the imaging device 408 may be adjusted. The adjustment to the imaging device may include an adjustment to a position or attitude of the imaging device. Such adjustment may be effected by translational or rotational movement the UAV and/or the carrier of the imaging device 408. Such an adjustment may be with respect to one, two, or three axes (e.g., pitch, roll, yaw). The adjustment to the imaging device may also include adjustment to the settings of the imaging device, such as a zoom, a focal length, an aperture, a shutter speed, and the like. After the adjustment to the imaging device, one or more additional image 410 may be captured by the imaging device. Such an image 410 may be compared to the template 402 and determined to be a match. If not, additional adjustment and/or composition evaluation may be implemented until a match occurs or until some terminal condition (e.g., expiration of time or user intervention) is reached.

According to embodiments, a user interface may be provided for a user to configure composition rules and/or composition templates. In some embodiments, such user interfaces may be provided on a remote terminal, such as a remote controller, a mobile device, a base station, a laptop, a desktop, and the like. The remote terminal may or may not be operably connected with the UAV. Information about such user-configured composition rules and/or templates can be stored by the remote terminal or transmitted to the UAV and used to evaluate the composition of images as described herein. FIGS. 5-6 illustrate exemplary user interfaces for configuring composition metrics, in accordance with embodiments.

Turning first to FIG. 5. As illustrated in user interface 500A, a user may be allowed to use the user interface (e.g., in configuration area 502) to select, deselect, or otherwise configure one or more composition metrics (e.g., rules) from a list of composition metrics. In some embodiments, the composition metrics may be provided by default, or generated automatically based on a user's profile or history, settings of an imaging device, configuration of the UAV, current environment information, and the like. For example, in some embodiments, relatively simple composition metrics may be provided for a novice user, or for a relatively lower-end imaging device, or for a UAV with more limited computational resources. Conversely, more complex composition metrics may be provided for a user who is a more experienced photographer, or for a higher-end imaging device, or for a UAV equipped with more computational resources. In some alternative embodiments, the opposite of the above may be implemented. That is, simpler metrics are provided for more experienced users, or higher-end imaging devices and/or UAV, and more complex metrics are provided for less experienced users, or lower-end imaging devices and/or UAV.

In some embodiments, the user interface may also allow a user to specify metric-specific information. For example, the user interface may allow a user to specify a weight value associated each composition metric. The weight value may be used in the calculation of the overall composition score of an image, as discussed elsewhere herein. In another example, the user interface may allow a user to specify one or more image types for which a given metric is applicable (e.g., portrait, group, landscape).

In some embodiments, the user interface may also allow a user to configure parameters applicable to the composition evaluation process. For instance, configuration area 504 may be used to specify a threshold score that is used to determine when the composition of an image is deemed satisfactory. For instance, if the composition score (based on the application of the selected composition metric(s)) is equal to or greater than the threshold score, then the imaging device may be controlled to take a picture. If the composition score is less than the threshold score, then further adjustment may be necessary to achieve improved composition (e.g., to adjust a position and/or orientation of the imaging device).

In some embodiments, the user interface may also allow a user to specify (e.g., in configuration area 506) parameters related to actions to be taken when the image composition is satisfactory. For example, the imaging device may be controlled (e.g., via shutter control) to capture one or more pictures when a previous image is considered satisfactory. A single image may be captured, or multiple images may be captured if a burst mode is selected. The rate of the burst mode may also be specified or selected by the user or provided by default.

In some embodiments, the user interface may also allow a user to specify (e.g., in configuration area 508) parameters related to actions to be taken when the image composition is not satisfactory and when adjustment is needed. For example, the user may specify the types of adjustment (e.g., translational and/or rotational movement) that are allowed for the UAV and/or for the imaging device.

In an embodiment, such as illustrated in user interface 500B of FIG. 5, a user may be allowed to select or deselect one or more composition templates from a list of composition templates (e.g., by checking or unchecking a checkbox or other similar control next to each composition template). Each composition template may comprise one or more composition rules. The user interface may allow a composition template to be expanded to show the composition rules contained therein. The rules contained in the composition template may be selected or unselected. The user interface may also allow a composition template to be collapsed to hide the composition rules contained therein. In some embodiments, the user may be allowed to specify the image types to which the composition templates are applicable.

FIG. 6 illustrates additional exemplary user interfaces for configuring a composition template, in accordance with embodiments. User interface 600A may be used by a user to select an image as a template, select a template from a list of templates, or create a custom template from scratch. User interface 600B may be used by a user to create a custom template. In some embodiments, a plurality of controls representing different template components may be provided. The template components may represent different types of objects, such as people, horizon, or other natural or man-made objects or regions. The template components may be dragged and dropped from template components area 608 of the user interface to their positions in the template area 610. Alternatively or additionally, the user may be able to hand-draw (e.g., using a hand or a stylus on a touchscreen, or a mouse) such template components directly in the template area 610. The resulting template may be saved and used for composition evaluation.

According to embodiments, image composition can be adjusted by adjusting a state of the imaging device and/or the UAV. In some embodiments, a deviation between a target composition and a current image composition of an image can be determined. The determination of the deviation can be based on comparing the image with the composition metrics (e.g., composition rules and/or the composition templates). The target composition (also referred to as the expected composition) can be defined by the composition metrics. Target composition can include, for example, a target position (also referred to as an expected position) or a target size (also referred to as an expected size) for a feature or element of the image such as a prominent line, a salient region, or an object of interest. For example, based on the rule of thirds, a target position for a prominent line may be at a one third line and a target position for a salient region may be at an intersection of such third lines. A deviation from the target composition can include a deviation from a target position and/or a target size. Based on the deviation, control signals can be generated for substantially correcting the deviation, so as to maintain the target/expected position and/or the target/expected size for one or more features, as discussed below.

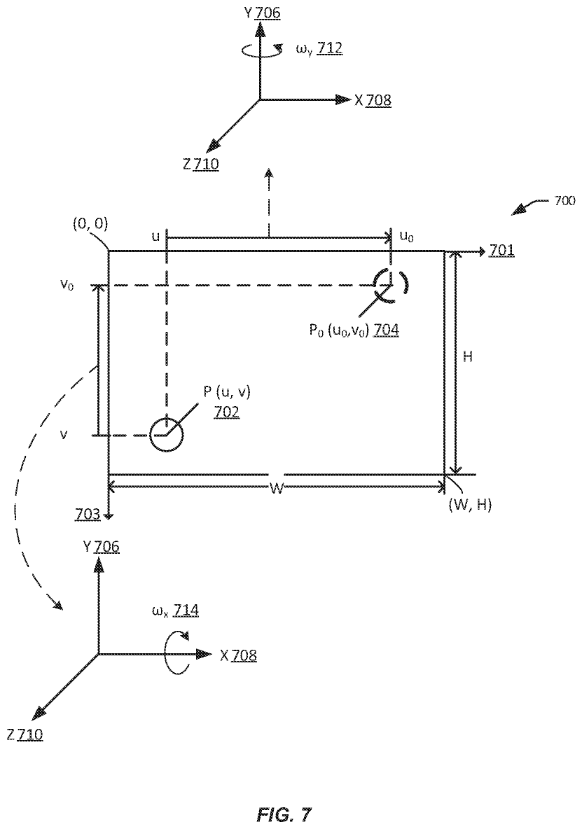

FIG. 7 illustrates an exemplary method for maintaining an expected position of a target within an image 700, in accordance with embodiments. The image 700 may be generated by an imaging payload, which may be coupled to a carrier that allows the payload to move relative to the carrier with respect to up to three axes of freedom, as described herein. The carrier may be coupled to a movable object such as a UAV. Assume that the image has a width of W pixels and a height of H pixels (where W and H are positive integers). A position within the image can be defined by a pair of coordinates along a horizontal axis 701 (along the width of the image) and a vertical axis 703 (along the height of the image), where the upper left corner of image has coordinates (0, 0) and the lower right corner of the image has coordinates (W, H).

Assume that a target, as captured in the image 700, is located at position P (u, v) 702, and the expected position of the target is P₀ (u₀, v₀) 704 that is different from P 702. In some embodiments, the expected position of the target P₀ (u₀, v₀) may be near the center of the image, such that u₀=W/2, and/or v₀=H/2. In other embodiment, the expected position of the target may be located anywhere else within the image (e.g., off-center). In various embodiments, the expected position of the target may or may not be the same as the initial position of the target. Assuming that the current position P is deviated from the expected position P₀ such that the deviation exceeds a predetermined threshold (such as expressed by a Δx from u₀, and a Δy from v₀), then an adjustment is required to bring the target position from P to close to the expected position P₀.

In some embodiments, the deviation from the expected target position can be used to derive one or more angular velocities for rotating the field of view of the imaging device (e.g., image sensor) around one or more axes. For example, deviation along the horizontal axis 701 of the image (e.g., between u and u₀) may be used to derive an angular velocity ω_{Y} 712 for rotating the field of view of the imaging device around the Y (yaw) axis 706, as follows:

ω_{Y}=α*(u−u₀), where α∈ [symbol] (real numbers) (1)

The rotation around the Y axis for the field of view of an imaging device may be achieved by a rotation of the movable object, a rotation of the payload (via a carrier) relative to the movable object, or a combination of both. In some embodiments, adjustment to the payload may be selected when adjustment to the movable object is infeasible or otherwise undesirable, for example, when the navigation path of the movable object is predetermined. In the equation (1), α is a constant that may be predefined and/or calibrated based on the configuration of the movable object (e.g., when the rotation is achieved by the movable object), the configuration of the carrier (e.g., when the rotation is achieved by the carrier), or both (e.g., when the rotation is achieved by a combination of the movable object and the carrier). In some embodiments, a is greater than zero(α>0). In other embodiments, α may be no greater than zero(α≤0). In some embodiments, α can be used to map a calculated pixel value to a corresponding control lever amount or sensitivity for controlling the angular velocity around a certain axis (e.g., yaw axis). In general, the control lever may be used to control the angular or linear movement of a controllable object (e.g., the carrier or the UAV). Greater control lever amount corresponds to greater sensitivity and greater speed (for angular or linear movement). In some embodiments, the control lever amount or a range thereof may be determined by configuration parameters of the flight control system for a UAV or configuration parameters of a control system for a carrier. The upper and lower bounds of the range of the control lever amount may include any arbitrary numbers. For example, the range of the control lever amount may be (1000, −1000) for one flight control system and (−1000, 1000) for another flight control system.

As an example, assume that the images have a width of W=1024 pixels and a height of H=768 pixels. Thus, the size of the images is 1024*768. Further assume that the expected position of the target has a u₀=512. Thus, (u−u₀)∈(−512, 512). Assume that the range of the control lever amount around the yaw axis is (−1000, 1000), then the maximum control lever amount or maximum sensitivity is 1000 and α=1000/512. Thus, the value of α can be affected by image resolution or size provided by the imaging device, range of the control lever amount (e.g., around a certain rotation axis), the maximum control lever amount or maximum sensitivity, and/or other factors.

For instance, when the rotation is achieved by rotation of the movable object with respect to the Y axis 706. The overall angular velocity of the field of view ω_{Y} is expressed as the angular velocity ω_{Y1} for the movable object:

ω_{Y}=ω_{Y1}=α₁*(u−u₀), where α₁∈ [symbol] (2)

In the equation (2), α₁ is a constant that is defined based on the configuration of the movable object. In some embodiments, α₁ is greater than zero (α₁>0). The α₁ can be defined similar to the α discussed above. For example, the value of α₁ may be defined based on image resolution or size and/or range of control lever amount for the movable object (e.g., around the yaw axis).

Similarly, when the rotation is achieved by the rotation of the payload relative to the movable object (e.g., via the carrier) with respect to the Y axis 706. The overall angular velocity of the field of view ω_{Y} is expressed as the angular velocity ω_{Y2} for the payload relative to the movable object:

ω_{Y}=ω_{Y2}=α₂*(u−u₀), where α₂∈ [symbol] (3)

In the equation (3), α₂ is a constant that is defined based on the configuration of the carrier and/or payload. In some embodiments, α₂ is greater than zero (α₂>0). The α₂ can be defined similar to the a discussed above. For example, the value of α₂ may be defined based on image resolution or size and/or range of control lever amount for the carrier (e.g., around the yaw axis).

In general, the angular velocity of the field of view around the Y (yaw) axis 706 can be expressed as a combination of the angular velocity ω_{Y1} for the movable object and the angular velocity ω_{Y2} for the payload relative to the movable object, such as the following:

ω_{Y}=ω_{Y1}+ω_{Y2} (4)

In the equation (4), either ω_{Y1} or ω_{Y2} may be zero.

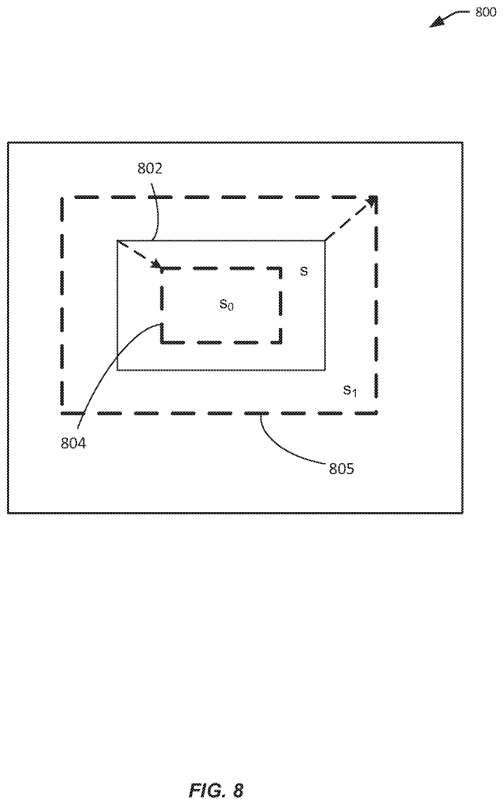

As illustrated herein, the direction of the rotation around the Y (yaw) axis may depend on the sign of u−u₀. For instance, if the expected position is located to the right of the actual position (as illustrated in FIG. 8), then u−u₀<0, and the field of view needs to rotate in a counter-clockwise fashion around the yaw axis 706 (e.g., pan left) in order to bring the target to the expected position. On the other hand, if the expected position is located to the left of the actual position, then u−u₀>0, and the field of view needs to rotate in a clockwise fashion around the yaw axis 706 (e.g., pan right) in order to bring the target to the expected position.

As illustrated herein, the speed of rotation (e.g., absolute value of the angular velocity) around a given axis (e.g., the Y (yaw) axis) may depend on the distance between the expected and the actual position of the target along the axis (i.e., |u−u₀|). The further the distance is, the greater the speed of rotation. Likewise, the closer the distance is, the slower the speed of rotation. When the expected position coincides with the position of the target along the axis (e.g., u=u₀), then the speed of rotation around the axis is zero and the rotation stops.

The method for adjusting the deviation from the expected target position and the actual target position along the horizontal axis 701, as discussed above, can be applied in a similar fashion to correct the deviation of the target along a different axis 703. For example, deviation along the vertical axis 703 of the image (e.g., between v and v₀) may be used to derive an angular velocity ω_{X} 714 for the field of view of the imaging device around the X (pitch) axis 708, as follows:

ω_{X}=β*(v−v₀), where β∈ [symbol] (5)

The rotation around the X axis for the field of view of an imaging device may be achieved by a rotation of the movable object, a rotation of the payload (via a carrier) relative to the movable object, or a combination of both. Hence, in the equation (5), β is a constant that may be predefined and/or calibrated based on the configuration of the movable object (e.g., when the rotation is achieved by the movable object), the configuration of the carrier (e.g., when the rotation is achieved by the carrier), or both (e.g., when the rotation is achieved by a combination of the movable object and the carrier). In some embodiments, β is greater than zero (β>0). In other embodiments, β may be no greater than zero (β≤0). In some embodiments, β can be used to map a calculated pixel value to a corresponding control lever amount for controlling the angular velocity around a certain axis (e.g., pitch axis). In general, the control lever may be used to control the angular or linear movement of a controllable object (e.g., UAV or carrier). Greater control lever amount corresponds to greater sensitivity and greater speed (for angular or linear movement). In some embodiments, the control lever amount or a range thereof may be determined by configuration parameters of the flight control system for a UAV or configuration parameters of a carrier control system for a carrier. The upper and lower bounds of the range of the control lever amount may include any arbitrary numbers. For example, the range of the control lever amount may be (1000, −1000) for one control system (e.g., flight control system or carrier control system) and (−1000, 1000) for another control system.

For instance, assume that the images have a width of W=1024 pixels and a height of H=768 pixels. Thus, the size of the images is 1024*768. Further assume that the expected position of the target has a v₀=384. Thus, (v−v₀)∈(−384, 384). Assume that the range of the control lever amount around the pitch axis is (−1000, 1000), then the maximum control lever amount or maximum sensitivity is 1000 and β=1000/384. Thus, the value of β can be affected by image resolution or size provided by the imaging device, range of the control lever amount (e.g., around a certain rotation axis), the maximum control lever amount or maximum sensitivity, and/or other factors.

For instance, when the rotation is achieved by rotation of the movable object with respect to the axis X 708, the angular velocity of the field of view ω_{X} is expressed as the angular velocity ω_{X1} for the movable object:

ω_{X}=ω_{X1}=β₁*(v−v₀), where β₁∈ [symbol] (6)

In the equation (6), β₁ is a constant that is defined based on the configuration of the movable object. In some embodiments, β₁ is greater than zero (β₁>0). The β₁ can be defined similar to the β discussed above. For example, the value of β₁ may be defined based on image resolution or size and/or range of control lever amount for the movable object (e.g., around the pitch axis).

Similarly, when the rotation is achieved by the rotation of the payload relative to the movable object (e.g., via the carrier) with respect to the axis X 708, the angular velocity of the field of view ω_{X} is expressed as the angular velocity ω_{X2} for the payload relative to the movable object:

ω_{X}=ω_{X2}=β₂*(v−v₀), where β₂∈ [symbol] (7)

In the equation (7), β₂ is a constant that is defined based on the configuration of the carrier and/or payload. In some embodiments, β₂ is greater than zero (β₂>0). The β₂ can be defined similar to the β discussed above. For example, the value of β₂ may be defined based on image resolution or size and/or range of control lever amount for the movable object (e.g., around the pitch axis).

In general, the angular velocity of the field of view around the X (pitch) axis 708 can be expressed as a combination of the angular velocity ω_{X1} for the movable object and the angular velocity ω_{X2} for the payload relative to the movable object, such as the following:

ω_{X}=ω_{X1}+ω_{X2} (8)

In the equation (8), either ω_{X1} or ω_{X2} may be zero.

As illustrated herein, the direction of the rotation around the X (yaw) axis may depend on the sign of v−v₀. For instance, if the expected position is located above of the actual position (as illustrated in FIG. 7), then v−v₀>0, and the field of view needs to rotate in a clockwise fashion around the pitch axis 708 (e.g., pitch down) in order to bring the target to the expected position. On the other hand, if the expected position is located to below the actual position, then v−v₀<0, and the field of view needs to rotate in a counter-clockwise fashion around the pitch axis 708 (e.g., pitch up) in order to bring the target to the expected position.

As illustrated herein, the speed of rotation (e.g., absolute value of the angular velocity) depends on the distance between the expected and the actual position of the target (i.e., |v−v₀|) along a give axis (e.g., the X (pitch) axis). The further the distance is, the greater the speed of rotation. The closer the distance is, the slower the speed of rotation. When the expected position coincides with the position of the target (e.g., v=v₀), then the speed of rotation is zero and the rotation stops.

In some embodiments, the values of the angular velocities as calculated above may be constrained or otherwise modified by various constraints of the system. Such constraints may include the maximum and/or minimum speed that may be achieved by the movable object and/or the imaging device, the range of control lever amount or the maximum control lever amount or maximum sensitivity of the control system for the movable object and/or the carrier, and the like. For example, the rotation speed may be the minimum of the calculated rotation speed and the maximum speed allowed.

FIG. 8 illustrates an exemplary method for maintaining an expected size of a target, in accordance with embodiments. Assume that a target 802 is captured by the image 800. The actual size of the target within the image can be s pixels (such as calculated as the product of the width of the target and the height of the target). The expected target size S may be smaller (e.g., the expected target may be represented by 804 and S=s₀) or larger (e.g., the expected target may be represented by 805 and S=s₁) than the actual size s. The expected size of the target may or may not be the same as the initial size of the target (e.g., as provided by the control terminal). Assuming that the current size s is deviated from the expected size s₀ or s₁ such that the deviation exceeds a predetermined threshold (such as a predefined Δs pixels), then an adjustment is required to bring the target size close to the expected size s₀ or s₁.

Although display area of the image and target is shown as rectangles, it is for illustrative purposes only and not intended to be limiting. Rather, the display area of the image and/or target may be of any suitable shapes in various embodiments such as circles, ovals, polygons, and the like. Likewise, although the areas discussed herein are expressed in pixels, these are for illustrative purposes only and not intended to be limiting. In other embodiments, the areas may be expressed in any suitable units such as megapixels, mm², cm², inch², and the like.

In some embodiments, the deviation from the expected target size can be used to derive one or more linear velocities for the movable object and/or imaging device along one or more axes. For example, deviation in the target size between actual target size s and the expected target size S (e.g., S=s₀ or s₁) can be used to determine a linear velocity V for moving the movable object along a Z (roll) axis 710, as follows:

V=δ*(1−s/S), where δ∈ [symbol] (9)

In the equation (9), δ is a constant that is defined based on the configuration of the movable object or any suitable controllable object (e.g., carrier) that may cause the field of view to move toward and/or away from the target. In some embodiments, δ is greater than zero (δ>0). In other embodiments, δ may be no greater than zero (δ≤0). In some embodiments, δ can be used to map a calculated pixel value to a corresponding control lever amount or sensitivity for controlling the linear velocity.

In general, V represents the velocity of the movable object toward or away from the target. The velocity vector points from the UAV to the target. If the actual size s of the target is smaller than the expected size S, then V>0 and the movable object moves towards the target so as to increase the size of the target as captured in the images. On the other hand, if the actual size s of the target is larger than the expected size S, then V<0 and the movable object moves away from the target so as to reduce the size of the target as captured in the images.

For instance, assume that the images have a width of W=1024 pixels and a height of H=768 pixels. Thus, the size of the images is 1024*768. Assume that the range of the control lever amount for controlling the linear velocity is (−1000, 1000). In an exemplary embodiment, δ=−1000 when s/S=3 and δ=1000 when s/S=1/3.

In some embodiments, the values of the velocities as calculated above may be constrained or otherwise modified by various constraints of the system. Such constraints may include the maximum and/or minimum speed that may be achieved by the movable object and/or the imaging device, the maximum sensitivity of the control system for the movable object and/or the carrier, and the like. For example, the speed for the movable object may be the minimum of the calculated speed and the maximum speed allowed.

Alternatively or additionally, the deviation between the actual target size and the expected target size can be used to derive adjustment to the operational parameters of the imaging device such as a zoom level or focal length in order to correct the deviation. Such adjustment to the imaging device may be necessary when adjustment to the movable object is infeasible or otherwise undesirable, for example, when the navigation path of the movable object is predetermined. An exemplary focal length adjustment F can be expressed as:

F=γ*(1−s/S), where γ∈ [symbol] (10)

Where γ is a constant that is defined based on the configuration of the imaging device. In some embodiments, γ is greater than zero (γ>0). In other embodiments, γ is no greater than zero (γ≤0). The value of γ may be defined based on the types of lenses and/or imaging devices.

If the actual size s of the target is smaller than the expected size S, then F>0 and the focal length increases by |F| so as to increase the size of the target as captured in the images. On the other hand, if the actual size s of the target is larger than the expected size S, then F<0 and the focal length decreases by |F| so as to reduce the size of the target as captured in the images. For example, in an embodiment, γ=10. This means that, for example, when the actual size of the target is double the size of the expected size S, the focal length should be decreased by 10 mm accordingly (i.e., F=10*(1−2/1)=−10) and vice versa.

In some embodiments, the adjustment to the operational parameters of the imaging device such as focal length may be constrained or otherwise modified by various constraints of the system. Such constraints may include, for example, the maximum and/or minimum focal lengths that may be achieved by the imaging device. As an example, assume the focal length range is (20 mm, 58 mm). Further assume that the initial focal length is 40 mm. Then when s>S, the focal length should be decreased according to equation (10); and when s<S, the focal length should be increased according to equation (10). However, such adjustment is limited by the lower and upper bounds of the focal length range (e.g., 20 mm to 58 mm). In other words, the post-adjustment focal length should be no less than the minimum focal length (e.g., 20 mm) and no more than the maximum focal length (e.g., 58 mm).

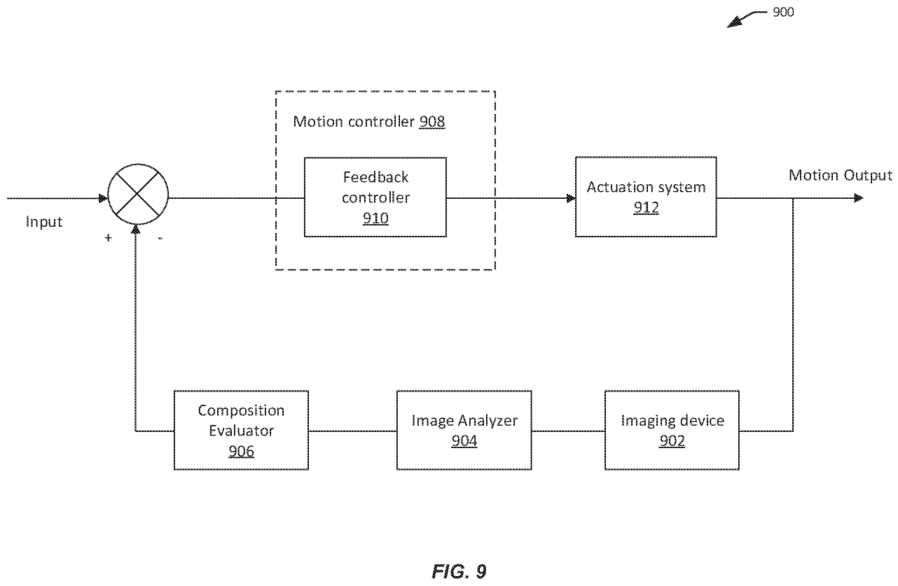

According to embodiments, a feedback control loop can be provided for adjusting movement of the imaging device. The adjustment to the movement may be achieved by controlling an actuation system of the UAV and/or the carrier of the imaging device. FIG. 9 illustrates an exemplary feedback control system 900 for adjusting movement of the imaging device, in accordance with some embodiments. The adjustment may be based on the change in position and/or size of one or more target features (e.g., salient regions, prominent lines, objects of interest) between a current image and a desired or target composition (e.g., defined by one or more composition rules or composition templates).

As shown in FIG. 9, a feedback control system 900 may comprise an imaging device 902, an image analyzer 904, a composition evaluator 906, a motion controller 908, and an actuation system 912. The motion controller may comprise a feedback controller 910. The feedback control system may be configured to obtain one or more motion components to minimize the change in position or size of the target features between the current image composition and the desired image composition. The motion components can include velocity components and/or acceleration components. The motion components can include translational or linear components (e.g., translational velocity or translational acceleration) and/or rotational or angular components (e.g., rotational acceleration or rotational acceleration). The motion components can be with respect to different axes. For example, a first motion component may be a translational velocity component along a first axis, and a second motion component may be a translational velocity component along a second axis. The motion components can be configured to minimize different changes or errors. For instance, the velocity components may comprise a first velocity component configured to minimize the change in size and a second velocity component configured to minimize the change in distance. In some embodiments, a single motion component may be obtained to minimize a change in size, a change in distance, or both.

The input to system may comprise a threshold positional offset and/or a threshold size offset. In some cases, the threshold offset may be zero or substantially zero, in order to minimize the positional error or the size error. In some other cases, the threshold positional offset or the threshold size offset may be non-zero to allow a margin of error between the current composition and the desired composition.

The imaging device 902 may be configured to capture image data. The image data may be provided to the image analyzer 904 and the composition evaluator 906. The image analyzer 904 and the composition evaluator 906 may be configured to analyze the image data and evaluate the image composition with respect to one or more composition metrics (e.g., composition rules or composition templates) to determine a change in position and/or a change in size of one or more target features. The change in position and/or the change in size may be compared against the input to obtain one or more error values. The error values may be provided to the feedback controller 910. The feedback controller 910 may use a proportional-integral-derivative (PID) method (or a proportional-derivative (PD) method) to minimize the one or more error values, thereby obtaining the one or more motion components. The motion components may be used to drive the actuation system 912. The actuation system 912 may be configured to actuate one or more actuators (e.g., rotors or motors) for the UAV and/or for the carrier. The motion components may be used to drive control signals configured to drive the one or more actuators, so as to achieve an adjustment movement for the UAV and/or imaging device. Such adjustment movement is the motion output of the feedback control system.

In some embodiments, the above steps may be repeated iteratively in a closed loop until the positional or size errors are equal to or less than a threshold positional offset and/or a threshold size offset.

In some embodiments, the composition evaluator 906 may be omitted, and the image analyzer 904 may be configured to analyze the image data to determine change in position and/or in size of target features between adjacent image frames. In such embodiments, the feedback controller system can be used to adjust the UAV and/or the carrier of the imaging device, so as to maintain substantially the same position and/or size for target features in the images.

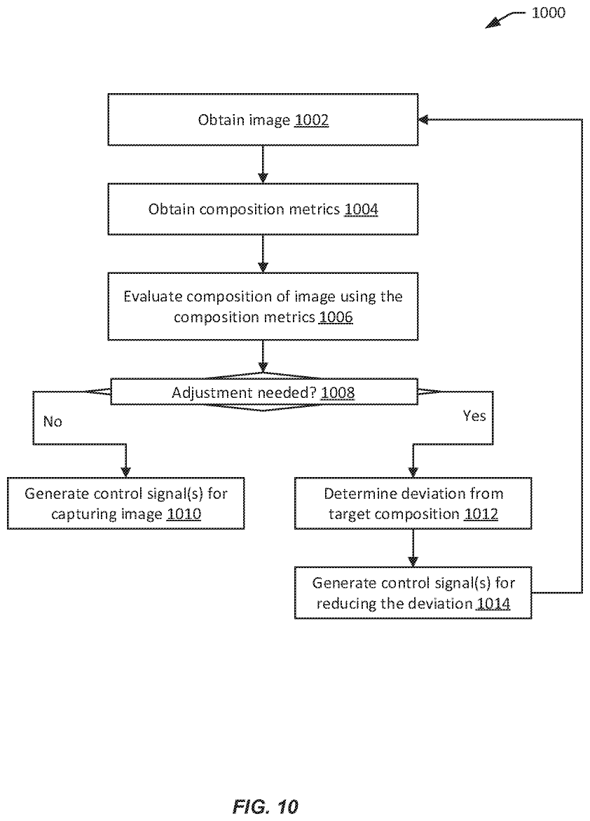

FIG. 10 illustrates an exemplary process 1000 for image capture, in accordance with embodiments. Some or all aspects of the process 1000 (or any other processes described herein, or variations and/or combinations thereof) may be performed by one or more processors onboard and/or offboard a movable object, such as a UAV. Some or all aspects of the process 1000 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

At block 1002, an image is obtained. The image can be a preview image obtained by an imaging device carried by a UAV. The imaging device may be coupled to the UAV via a carrier. The carrier may or may not permit the imaging device to move relative translationally or rotationally relative to the UAV. The image may be transmitted to a remote terminal via a communication channel, where the image is evaluated by one or more processors on the remote terminal. Alternatively, the image may be processed by one or more processors in the imaging device, or on the UAV.

In block 1004, one or more composition metrics (e.g., composition templates or composition rules) are obtained. The composition metrics may be selected from a plurality of available composition metrics. In some embodiments, the selection may be automated without human intervention. For instance, default composition metrics may be used. Or, the composition metrics used for evaluating a previous image may be used for evaluating a subsequent image.

In some embodiments, the image may be analyzed, by one or more processors, to determine contextual information with respect to the image. The contextual information may comprise a scene or an environment of the image. Based on the determined scene or environment, one or more composition metrics may be selected.

In some embodiments, the image may be evaluated with respect to each of the plurality of composition metrics to determine a metric score. The metric score may indicate how well the given metric matches or is otherwise suitable for the image. The metric score may or may not be the same as composition score discussed herein. The suitability of the composition metric may be based on contextual information of the image or a composition of the image.

In some other embodiments, the selection of the composition templates or rules may require some human intervention. For instance, a user operating a remote terminal may manually select the one or more composition templates or rules for use. The user selection may or may not be based on the obtained image. The user selection may or may not be based on composition metrics that are pre-selected by the automated process.

In some embodiments, the one or more composition metrics may be created, edited, or otherwise configured by a user. Such configuration may occur offline when the UAV or the imaging device is not operating. For instance, prior to operation of the UAV and/or the imaging device, data representing the composition metrics may be created offline and pre-loaded to a memory unit accessible to the one or more processors that are configured to evaluate image composition. Alternatively, such configuration may occur online while the UAV and/or the imaging device is operating. For instance, during operation of the UAV and/or the imaging device, a user may use a remote terminal to create or edit the composition templates or rules. Data representing the composition or rules may be transmitted in real time or in nearly real time to the UAV or imaging device for use while the UAV and/or imaging device is operating.

In some embodiments, a user interface, such as those discussed in FIGS. 5-6, may be provided for a user to configure the composition metrics. The user interface may also allow a user to specify and/or associate attributes such as weight or image type with the composition templates or rules. The user may also use the same or a different user interface to specify some parameters pertinent to the composition evaluation process, such as a threshold composition score or a threshold metric score that is used to determine whether to capture a picture or to effect further adjustment. The user may also use the same or a different user interface to specify parameters related to actions to be taken when the image composition is satisfactory and/or when adjustment is necessary to achieve the optimal or target composition.

In block 1006, a composition of the image is evaluated using the one or more composition metrics (e.g., composition templates or rules). The image may be processed and analyzed to detect and/or extract features such as salient regions or prominent lines. Attributes of and spatial relationship between such features may also be determined. The features may be detected/extracted by an automated process, e.g., using machine learning techniques. Alternatively, such features may be identified by a human user. For instance, the image may be displayed to a user on a remote terminal. The user may select features to be used for composition evaluation purposes (e.g., persons, salient regions, prominent lines, objects of interest) using a touch screen or any other suitable input device.

The composition of the image may be evaluated with respect to the composition rules or templates obtained in block 1004. The evaluation may be based on features extracted from the image, which represent the composition of the image. For example, a composition score that indicates an aesthetic level of the current image may be determined for the current composition based on the composition metrics. In an embodiment, the spatial arrangement of the features may be evaluated against each composition rule to derive a rule score for the rule. The rule score may then be combined to derive the overall composition score. In some cases, each rule may be associated with a weight value that indicates an importance of the rule, and the rule scores may be weighted with the respective weight value before being combined to derive the composition score.

Likewise, a composition score may be derived for a composition template. The composition of the composition template may be compared with that of the composition template. In some embodiments, features of the image under evaluation may be matched with corresponding features of the composition template. Then, the spatial arrangement of the features of the image may be compared with the spatial arrangement of the features of the template. The more closely the spatial arrangement of the image features resembles the spatial arrangement of the template features, the higher the composition score may be. In some embodiments, multiple composition templates may be used to evaluate an image. In such embodiments, a template score may be determined for each template and the template scores may be combined to determine the overall composition score, in a manner similar to the combination of rules scores. For example, the template scores may be weighted by respective template weight values.

In block 1008, it is determined whether an adjustment is needed based on the evaluation at block 1006. The adjustment may be necessary to achieve an optimal or target composition that represents the composition metrics. In some embodiments, a composition score may be compared with a predetermined threshold score. If the composition score is less than the threshold score, then the current composition may be considered satisfactory and no adjustment is necessary. Otherwise, if the composition score is equal to or greater than the threshold score, then adjustment to the composition may be necessary for achieving the optimal or target composition. In some embodiments, a user input may be used to determine whether adjustment is needed. For instance, the image, a comparison between or an interposition of the image and a target composition may be displayed to a user on a remote terminal and the user may indicate, via the remote terminal, whether to adjust the composition of the image via adjustment to the UAV and/or the carrier of the imaging device.

If it is determined at block 1008 that an adjustment is needed, then in block 1012 a deviation of the current composition from the target composition may be calculated. The deviation may comprise a deviation in distance or in size (e.g., in pixels). The deviation may be calculated as a difference in size and/or position between the bounding boxes of corresponding features. For instance, according to the rule of thirds, an object of interest should be positioned at an intersection point of two third lines. In this case, the deviation between a current position of the object of interest and the intersection point may be determined. As another example, a transformation or a motion vector between a current image and a composition template may be calculated based on feature matching. The transformation may be used to control movement of the UAV and/or the carrier. In some embodiments, the block 1012 may be implemented as part of the evaluation in block 1006 or the decision block 1008.

In block 1014, control signals can be generated for reducing the deviation calculated in block 1012. For example, the control signals may be configured to adjust a state (e.g., position, attitude, velocity, acceleration) of the UAV and/or the carrier of the imaging device. Various image tracking methods may be used to generate such control signals, including but not limited to those discussed in FIGS. 7-8. For example, based on the deviation, a change in position or attitude for the UAV and/or the carrier of the imaging device may be determined in order to achieve the target size and/or position of one or more features in the image coordinate system. The change in position or attitude for the UAV and/or the carrier may be in calculated for a navigation coordinate system, for example. A movement for the UAV and/or the carrier may be calculated. The movement may be translational or rotational. For example, the control signals may be configured to control the carrier to rotate around up to three axes, while the UAV hovers. As another example, the control signals may be configured to control the UAV to move translationally and/or rotationally in order to adjust a position and/or attitude of the UAV. Control signals for effecting the movement (e.g., by controlling a velocity and/or an acceleration) may be generated. In some embodiments, a feedback control mechanism may be used, as discussed elsewhere herein.

In some embodiments, the generation of the control signals can be based at least in part on sensing data from one or more sensors carried by the UAV and/or the carrier such as inertial measurement units (IMUs), GPS receivers, magnetometers, and the like. For example, any suitable sensor fusion techniques may be applied to fuse the sensing data, and the fused sensing data may be used, in addition to the image data, to generate the control signals.

In addition to or instead of adjustment to the UAV and/or carrier, the control signals may be used to adjust one or more parameters of the imaging device itself in order to reduce the deviation. The parameters may include, without limitation, a zoom level, a focal length, a shutter speed, an aperture, or any other suitable parameters. For example, the zoom of the imaging device may be changed to resize an object in the image.

After the adjustment described above, the process 1000 may be repeated to obtain and evaluate additional post-adjustment images (e.g., preview images) until the composition is satisfactory. The iterative process 1000 may also terminal upon certain terminal conditions such as expiration of a predetermined time period, or in response to a user intervention.

If it is determined at block 1008 that an adjustment is not needed, then in block 1010, one or more control signals may be generated for capturing one or more images. The control signals may be used to control a shutter (e.g., mechanical or electronic shutter) of the imaging device to “take a picture”. A single picture, or multiple pictures (e.g., in burst mode) may be taken based on the shutter control. In some embodiments, the captured images (e.g., recorded images) may be transmitted to a remote terminal for display. In some embodiments, the control signals for the imaging device can optionally include signals for switching a mode of the imaging device from a preview or live view mode to an image capture mode.

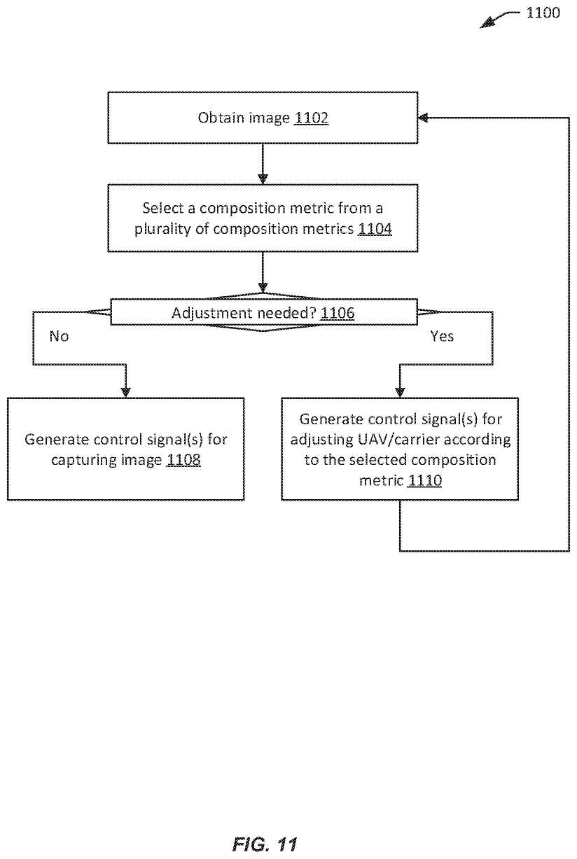

FIG. 11 illustrates another exemplary process 1100 for image capture, in accordance with embodiments.

In block 1102, an image is obtained. The image may be obtained in a manner similar to the description of block 1002 of FIG. 10.

In block 1104, a composition metric is selected from a plurality of composition metrics (e.g., composition rules and/or composition templates). The plurality of composition metrics may be provided by default by the system or provided by a user. In some embodiments, selecting the composition metric can comprise evaluating the image with respect to some or all of the plurality of composition metrics. In some embodiments, the evaluation may yield a metric score associated with each of the composition metrics that is evaluated. The metric score may indicate how well the given metric matches or is otherwise suitable for the image. For example, a higher metric score may indicate a higher suitability or match between a given composition metric and the image. In another example, the opposite may be true (i.e., a lower metric score indicates a lower suitability). In some embodiments, the metric score can be determined based on contextual information of the image, such as a scene, a location, or an environment, as described elsewhere herein. For example, certain composition metrics may be more applicable or pertinent to certain types of scenes. If so, then the metric scores for such metrics may be higher. In some embodiments, the metric score can be determined based on a composition of the image. For example, prominent features of the image, such as salient regions and prominent lines, may be extracted. The extracted features may be evaluated with respect to each composition metric to determine the metric score. In this case, the determination of the metric score may be similar to the determination of the composition score discussed herein.

In block 1106, it is determined whether adjustment is needed to achieve the optimal composition as defined by the selected composition metric. In some embodiments, the metric score of the selected composition metric may be compared with a threshold score. If the metric score is equal to or greater than the threshold score, then it may be determined that no adjustment is needed. In block 1108, control signals for capturing image can be generated, for example, in a manner as described in block 1010 of FIG. 10. Otherwise, if it is determined that further adjustment is needed, then in block 1110, control signals can be generated for adjusting the UAV and/or the carrier of the imaging device according to the selected composition metric.

In some embodiments, generating control signals according to the selected composition metric comprises determining a deviation in distance and/or in size between corresponding features in the image and in the composition metric. Various image tracking methods may be used to generate such control signals, including but not limited to those discussed in FIGS. 7-8. For example, based on the deviation, a change in position or attitude for the UAV and/or the carrier of the imaging device may be determined in order to achieve the target size and/or position of one or more features in the image coordinate system. The change in position or attitude for the UAV and/or the carrier may be in calculated for a navigation coordinate system, for example. A movement for the UAV and/or the carrier may be calculated. The movement may be translational or rotational. For example, the control signals may be configured to control the carrier to rotate around up to three axes, while the UAV hovers. As another example, the control signals may be configured to control the UAV to move translationally and/or rotationally in order to adjust a position and/or attitude of the UAV. Control signals for effecting the movement (e.g., by controlling a velocity and/or an acceleration) may be generated. In some embodiments, a feedback control mechanism may be used, as discussed elsewhere herein. The deviation may be calculated as a difference in size and/or position between the bounding boxes of corresponding features, for example. The deviation may indicate a deviation between a composition of the image and a target composition defined by the selected composition metric. Control signals may be generated to reduce the deviation. For example, based on the deviation, a change in position or attitude for the UAV and/or the carrier of the imaging device may be determined in order to achieve the target size and/or position of one or more features in the image coordinate system. The change in position or attitude for the UAV and/or the carrier may be in calculated for a navigation coordinate system, for example. A movement for the UAV and/or the carrier may be calculated and the movement may be translational or rotational. Control signals for effecting the movement (e.g., by controlling a velocity and/or an acceleration) may be generated. In some embodiments, a feedback control mechanism may be used, as discussed elsewhere herein.

In some embodiments, the generation of the control signals can be based at least in part on sensing data from one or more sensors carried by the UAV and/or the carrier such as inertial measurement units (IMUs), GPS receivers, magnetometers, and the like. For example, any suitable sensor fusion techniques may be applied to fuse the sensing data, and the fused sensing data may be used, in addition to the image data, to generate the control signals.

In addition to or instead of adjustment to the UAV and/or carrier, the control signals may be used to adjust one or more parameters of the imaging device itself. For example, a zoom level, a focal length, a shutter speed, an aperture, or any other parameters of the imaging device may be adjusted. After the adjustment, the process 1100 may be repeated to obtain and evaluate additional images (e.g., preview images) until the composition is satisfactory. The iterative process may also terminate after a predetermined time period has expired, or in response to user intervention.

Advantageously, the disclosed techniques can be used to achieve optimal image composition for aerial photography with no or little user intervention. For example, a position and/or orientation of the UAV and/or the carrier of the imaging device can be adjusted automatically according to one or more composition metrics. Furthermore, a shutter of the imaging device can be controlled automatically to capture photographs when the composition is determined optimal. Accordingly, the disclosed techniques can greatly lower the user requirement for aerial photography, enabling a layperson not experienced in photographic composition to easily compose and capture aesthetically-pleasing images using a UAV. By removing or reducing human errors, the disclosed techniques can also increase the efficiency and accuracy for achieving optimal composition in aerial photography.

The systems, devices, and methods described herein can be applied to a wide variety of movable objects. As previously mentioned, any description herein of an aerial vehicle, such as a UAV, may apply to and be used for any movable object. Any description herein of an aerial vehicle may apply specifically to UAVs. A movable object of the present invention can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be carried by a living subject, or take off from a living subject, such as a human or an animal. Suitable animals can include avines, canines, felines, equines, bovines, ovines, porcines, delphines, rodents, or insects.

The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

In some instances, the movable object can be an aerial vehicle. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). An aerial vehicle can be self-propelled, such as self-propelled through the air. A self-propelled aerial vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. The movable object may be controlled remotely via an occupant within a separate vehicle. In some embodiments, the movable object is an unmanned movable object, such as a UAV. An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

The movable object can have any suitable size and/or dimensions. In some embodiments, the movable object may be of a size and/or dimensions to have a human occupant within or on the vehicle. Alternatively, the movable object may be of size and/or dimensions smaller than that capable of having a human occupant within or on the vehicle. The movable object may be of a size and/or dimensions suitable for being lifted or carried by a human. Alternatively, the movable object may be larger than a size and/or dimensions suitable for being lifted or carried by a human. In some instances, the movable object may have a maximum dimension (e.g., length, width, height, diameter, diagonal) of less than or equal to about: 2 cm, 5 cm, 10 cm, 50 cm, 1 m, 2 m, 5 m, or 10 m. The maximum dimension may be greater than or equal to about: 2 cm, 5 cm, 10 cm, 50 cm, 1 m, 2 m, 5 m, or 10 m. For example, the distance between shafts of opposite rotors of the movable object may be less than or equal to about: 2 cm, 5 cm, 10 cm, 50 cm, 1 m, 2 m, 5 m, or 10 m. Alternatively, the distance between shafts of opposite rotors may be greater than or equal to about: 2 cm, 5 cm, 10 cm, 50 cm, 1 m, 2 m, 5 m, or 10 m.

In some embodiments, the movable object may have a volume of less than 100 cm×100 cm×100 cm, less than 50 cm×50 cm×30 cm, or less than 5 cm×5 cm×3 cm. The total volume of the movable object may be less than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³3, 1 m³, or 10 m³. Conversely, the total volume of the movable object may be greater than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

In some embodiments, the movable object may have a footprint (which may refer to the lateral cross-sectional area encompassed by the movable object) less than or equal to about: 32,000 cm², 20,000 cm², 10,000 cm², 1,000 cm², 500 cm², 100 cm², 50 cm², 10 cm², or 5 cm². Conversely, the footprint may be greater than or equal to about: 32,000 cm², 20,000 cm², 10,000 cm², 1,000 cm², 500 cm², 100 cm², 50 cm², 10 cm², or 5 cm².

In some instances, the movable object may weigh no more than 1000 kg. The weight of the movable object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a movable object may be small relative to a load carried by the movable object. The load may include a payload and/or a carrier, as described in further detail elsewhere herein. In some examples, a ratio of a movable object weight to a load weight may be greater than, less than, or equal to about 1:1. In some instances, a ratio of a movable object weight to a load weight may be greater than, less than, or equal to about 1:1. Optionally, a ratio of a carrier weight to a load weight may be greater than, less than, or equal to about 1:1. When desired, the ratio of an movable object weight to a load weight may be less than or equal to: 1:2, 1:3, 1:4, 1:5, 1:10, or even less. Conversely, the ratio of a movable object weight to a load weight can also be greater than or equal to: 2:1, 3:1, 4:1, 5:1, 10:1, or even greater.

In some embodiments, the movable object may have low energy consumption. For example, the movable object may use less than about: 5 W/h, 4 W/h, 3 W/h, 2 W/h, 1 W/h, or less. In some instances, a carrier of the movable object may have low energy consumption. For example, the carrier may use less than about: 5 W/h, 4 W/h, 3 W/h, 2 W/h, 1 W/h, or less. Optionally, a payload of the movable object may have low energy consumption, such as less than about: 5 W/h, 4 W/h, 3 W/h, 2 W/h, 1 W/h, or less.

The UAV can include a propulsion system having four rotors. Any number of rotors may be provided (e.g., one, two, three, four, five, six, or more). The rotors, rotor assemblies, or other propulsion systems of the unmanned aerial vehicle may enable the unmanned aerial vehicle to hover/maintain position, change orientation, and/or change location. The distance between shafts of opposite rotors can be any suitable length. For example, the length can be less than or equal to 2 m, or less than equal to 5 m. In some embodiments, the length can be within a range from 40 cm to 1 m, from 10 cm to 2 m, or from 5 cm to 5 m. Any description herein of a UAV may apply to a movable object, such as a movable object of a different type, and vice versa.

In some embodiments, the movable object can be configured to carry a load. The load can include one or more of passengers, cargo, equipment, instruments, and the like. The load can be provided within a housing. The housing may be separate from a housing of the movable object, or be part of a housing for a movable object. Alternatively, the load can be provided with a housing while the movable object does not have a housing. Alternatively, portions of the load or the entire load can be provided without a housing. The load can be rigidly fixed relative to the movable object. Optionally, the load can be movable relative to the movable object (e.g., translatable or rotatable relative to the movable object). The load can include a payload and/or a carrier, as described elsewhere herein.

In some embodiments, the movement of the movable object, carrier, and payload relative to a fixed reference frame (e.g., the surrounding environment) and/or to each other, can be controlled by a terminal. The terminal can be a remote control device at a location distant from the movable object, carrier, and/or payload. The terminal can be disposed on or affixed to a support platform. Alternatively, the terminal can be a handheld or wearable device. For example, the terminal can include a smartphone, tablet, laptop, computer, glasses, gloves, helmet, microphone, or suitable combinations thereof. The terminal can include a user interface, such as a keyboard, mouse, joystick, touchscreen, or display. Any suitable user input can be used to interact with the terminal, such as manually entered commands, voice control, gesture control, or position control (e.g., via a movement, location or tilt of the terminal).

The terminal can be used to control any suitable state of the movable object, carrier, and/or payload. For example, the terminal can be used to control the position and/or orientation of the movable object, carrier, and/or payload relative to a fixed reference from and/or to each other. In some embodiments, the terminal can be used to control individual elements of the movable object, carrier, and/or payload, such as the actuation assembly of the carrier, a sensor of the payload, or an emitter of the payload. The terminal can include a wireless communication device adapted to communicate with one or more of the movable object, carrier, or payload.

The terminal can include a suitable display unit for viewing information of the movable object, carrier, and/or payload. For example, the terminal can be configured to display information of the movable object, carrier, and/or payload with respect to position, translational velocity, translational acceleration, orientation, angular velocity, angular acceleration, or any suitable combinations thereof. In some embodiments, the terminal can display information provided by the payload, such as data provided by a functional payload (e.g., images recorded by a camera or other image capturing device).

Optionally, the same terminal may both control the movable object, carrier, and/or payload, or a state of the movable object, carrier and/or payload, as well as receive and/or display information from the movable object, carrier and/or payload. For example, a terminal may control the positioning of the payload relative to an environment, while displaying image data captured by the payload, or information about the position of the payload. Alternatively, different terminals may be used for different functions. For example, a first terminal may control movement or a state of the movable object, carrier, and/or payload while a second terminal may receive and/or display information from the movable object, carrier, and/or payload. For example, a first terminal may be used to control the positioning of the payload relative to an environment while a second terminal displays image data captured by the payload. Various communication modes may be utilized between a movable object and an integrated terminal that both controls the movable object and receives data, or between the movable object and multiple terminals that both control the movable object and receives data. For example, at least two different communication modes may be formed between the movable object and the terminal that both controls the movable object and receives data from the movable object.

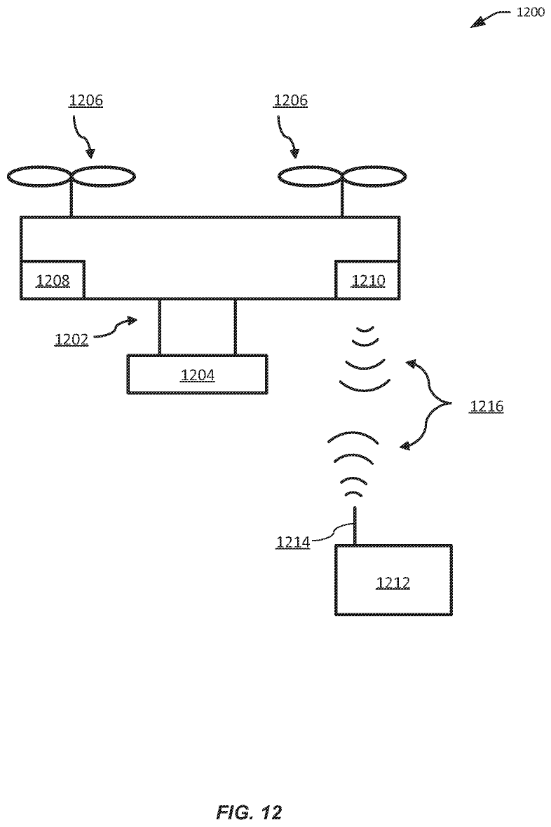

FIG. 12 illustrates a movable object 1200 including a carrier 1202 and a payload 1204, in accordance with embodiments. Although the movable object 1200 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 1204 may be provided on the movable object 1200 without requiring the carrier 1202. The movable object 1200 may include propulsion mechanisms 1206, a sensing system 1208, and a communication system 1210.

The propulsion mechanisms 1206 can include one or more of rotors, propellers, blades, engines, motors, wheels, axles, magnets, or nozzles, as previously described. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1206 can be mounted on the movable object 1200 using any suitable means, such as a support element (e.g., a drive shaft) as described elsewhere herein. The propulsion mechanisms 1206 can be mounted on any suitable portion of the movable object 1200, such on the top, bottom, front, back, sides, or suitable combinations thereof

In some embodiments, the propulsion mechanisms 1206 can enable the movable object 1200 to take off vertically from a surface or land vertically on a surface without requiring any horizontal movement of the movable object 1200 (e.g., without traveling down a runway). Optionally, the propulsion mechanisms 1206 can be operable to permit the movable object 1200 to hover in the air at a specified position and/or orientation. One or more of the propulsion mechanisms 1206 may be controlled independently of the other propulsion mechanisms. Alternatively, the propulsion mechanisms 1206 can be configured to be controlled simultaneously. For example, the movable object 1200 can have multiple horizontally oriented rotors that can provide lift and/or thrust to the movable object. The multiple horizontally oriented rotors can be actuated to provide vertical takeoff, vertical landing, and hovering capabilities to the movable object 1200. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1200 (e.g., with respect to up to three degrees of translation and up to three degrees of rotation).

The sensing system 1208 can include one or more sensors that may sense the spatial disposition, velocity, and/or acceleration of the movable object 1200 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1208 can be used to control the spatial disposition, velocity, and/or orientation of the movable object 1200 (e.g., using a suitable processing unit and/or control module, as described below). Alternatively, the sensing system 1208 can be used to provide data regarding the environment surrounding the movable object, such as weather conditions, proximity to potential obstacles, location of geographical features, location of manmade structures, and the like.

The communication system 1210 enables communication with terminal 1212 having a communication system 1214 via wireless signals 1216. The communication systems 1210, 1214 may include any number of transmitters, receivers, and/or transceivers suitable for wireless communication. The communication may be one-way communication; such that data can be transmitted in only one direction. For example, one-way communication may involve only the movable object 1200 transmitting data to the terminal 1212, or vice-versa. The data may be transmitted from one or more transmitters of the communication system 1210 to one or more receivers of the communication system 1214, or vice-versa. Alternatively, the communication may be two-way communication, such that data can be transmitted in both directions between the movable object 1200 and the terminal 1212. The two-way communication can involve transmitting data from one or more transmitters of the communication system 1210 to one or more receivers of the communication system 1214, and vice-versa.

In some embodiments, the terminal 1212 can provide control data to one or more of the movable object 1200, carrier 1202, and payload 1204 and receive information from one or more of the movable object 1200, carrier 1202, and payload 1204 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1206), or a movement of the payload with respect to the movable object (e.g., via control of the carrier 1202). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1208 or of the payload 1204). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1212 can be configured to control a state of one or more of the movable object 1200, carrier 1202, or payload 1204. Alternatively or in combination, the carrier 1202 and payload 1204 can also each include a communication module configured to communicate with terminal 1212, such that the terminal can communicate with and control each of the movable object 1200, carrier 1202, and payload 1204 independently.

In some embodiments, the movable object 1200 can be configured to communicate with another remote device in addition to the terminal 1212, or instead of the terminal 1212. The terminal 1212 may also be configured to communicate with another remote device as well as the movable object 1200. For example, the movable object 1200 and/or terminal 1212 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1200, receive data from the movable object 1200, transmit data to the terminal 1212, and/or receive data from the terminal 1212. Optionally, the remote device can be connected to the Internet or other telecommunications network, such that data received from the movable object 1200 and/or terminal 1212 can be uploaded to a website or server.

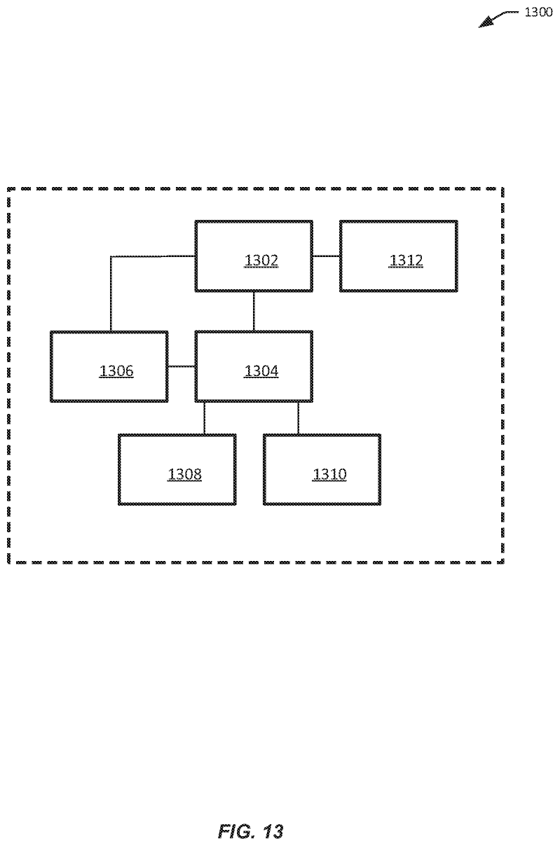

FIG. 13 is a schematic illustration by way of block diagram of a system 1300 for controlling a movable object, in accordance with embodiments. The system 1300 can be used in combination with any suitable embodiment of the systems, devices, and methods disclosed herein. The system 1300 can include a sensing module 1302, processing unit 1304, non-transitory computer readable medium 1306, control module 1308, and communication module 1310.

The sensing module 1302 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1302 can be operatively coupled to a processing unit 1304 having a plurality of processors. In some embodiments, the sensing module can be operatively coupled to a transmission module 1312 (e.g., a Wi-Fi image transmission module) configured to directly transmit sensing data to a suitable external device or system. For example, the transmission module 1312 can be used to transmit images captured by a camera of the sensing module 1302 to a remote terminal.

The processing unit 1304 can have one or more processors, such as a programmable or non-programmable processor (e.g., a central processing unit (CPU), a microprocessor, an FPGA, an application-specific integrated circuit (ASIC)). The processing unit 1304 can be operatively coupled to a non-transitory computer readable medium 1306. The non-transitory computer readable medium 1306 can store logic, code, and/or program instructions executable by the processing unit 1304 for performing one or more steps. The non-transitory computer readable medium can include one or more memory units (e.g., removable media or external storage such as an SD card or random access memory (RAM)). In some embodiments, data from the sensing module 1302 can be directly conveyed to and stored within the memory units of the non-transitory computer readable medium 1306. The memory units of the non-transitory computer readable medium 1306 can store logic, code and/or program instructions executable by the processing unit 1304 to perform any suitable embodiment of the methods described herein. The memory units can store sensing data from the sensing module to be processed by the processing unit 1304. In some embodiments, the memory units of the non-transitory computer readable medium 1306 can be used to store the processing results produced by the processing unit 1304.

In some embodiments, the processing unit 1304 can be operatively coupled to a control module 1308 configured to control a state of the movable object. For example, the control module 1308 can be configured to control the propulsion mechanisms of the movable object to adjust the spatial disposition, velocity, and/or acceleration of the movable object with respect to six degrees of freedom. Alternatively or in combination, the control module 1308 can control one or more of a state of a carrier, payload, or sensing module.

The processing unit 1304 can be operatively coupled to a communication module 1310 configured to transmit and/or receive data from one or more external devices (e.g., a terminal, display device, or other remote controller). Any suitable means of communication can be used, such as wired communication or wireless communication. For example, the communication module 1310 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1310 can transmit and/or receive one or more of sensing data from the sensing module 1302, processing results produced by the processing unit 1304, predetermined control data, user commands from a terminal or remote controller, and the like.

The components of the system 1300 can be arranged in any suitable configuration. For example, one or more of the components of the system 1300 can be located on the movable object, carrier, payload, terminal, sensing system, or an additional external device in communication with one or more of the above. Additionally, although FIG. 13 depicts a single processing unit 1304 and a single non-transitory computer readable medium 1306, one of skill in the art would appreciate that this is not intended to be limiting, and that the system 1300 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1300 can occur at one or more of the aforementioned locations.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method, comprising:
obtaining an image from an imaging device carried by an unmanned aerial vehicle (UAV), the imaging device being coupled to the UAV via a carrier that permits the imaging device to move relative to the UAV with respect to one or more axes;
obtaining one or more composition metrics;
evaluating a composition of the image using the one or more composition metrics; and
controlling the UAV or the carrier based at least in part on the evaluation.

2. The method of claim 1, wherein obtaining the one or more composition metrics comprises selecting the one or more composition metrics from a plurality of composition metrics based on the image.

3. The method of claim 1, wherein the one or more composition metrics are configurable via a user interface on a remote terminal.

4. The method of claim 1, wherein the one or more composition metrics comprise one or more composition rules.

5. The method of claim 1, wherein the one or more composition metrics comprise one or more composition templates.

6. The method of claim 1, wherein controlling the UAV or the carrier based at least in part on the evaluation comprises:
determining a deviation between the composition of the image and a target composition defined by the one or more composition metrics; and
generating control signals for adjusting a position or an attitude of the UAV or the carrier to reduce the deviation.

7. The method of claim 1, wherein evaluating the composition of the image comprises:
determining a composition score for the image based on the one or more composition metrics; and
comparing the composition score with a predetermined threshold score.

8. The method of claim 7, wherein controlling the UAV or the carrier based at least in part on the evaluation comprises generating control signals for controlling the UAV or the carrier in response to determining that the composition score is less than the predetermined threshold score.

9. The method of claim 1, further comprising controlling a shutter of the imaging device to capture another image based at least in part on the evaluation.

10. The method of claim 1, further comprising adjusting one or more parameters of the imaging device based at least in part on the evaluation.

11. A system, comprising:
a memory that stores one or more computer-executable instructions; and
one or more processors configured to access the memory and execute the computer-executable instructions to perform a method comprising:
obtaining an image from an imaging device carried by an unmanned aerial vehicle (UAV), the imaging device being coupled to the UAV via a carrier that permits the imaging device to move relative to the UAV with respect to one or more axes;
obtaining one or more composition metrics;
evaluating a composition of the image using the one or more composition metrics; and
controlling the UAV or the carrier based at least in part on the evaluation.

12. The system of claim 11, wherein obtaining the one or more composition metrics comprises selecting the one or more composition metrics from a plurality of composition metrics based on the image.

13. The system of claim 11, wherein the one or more composition metrics are configurable via a user interface on a remote terminal.

14. The system of claim 11, wherein the one or more composition metrics comprise one or more composition rules.

15. The system of claim 11, wherein the one or more composition metrics comprise one or more composition templates.

16. The system of claim 11, wherein controlling the UAV or the carrier based at least in part on the evaluation comprises:
determining a deviation between the composition of the image and a target composition defined by the one or more composition metrics; and
generating control signals for adjusting a position or an attitude of the UAV or the carrier to reduce the deviation.

17. The system of claim 11, wherein evaluating the composition of the image comprises:
determining a composition score for the image based on the one or more composition metrics; and
comparing the composition score with a predetermined threshold score.

18. The system of claim 17, wherein controlling the UAV or the carrier based at least in part on the evaluation comprises generating control signals for controlling the UAV or the carrier in response to determining that the composition score is less than the predetermined threshold score.

19. The system of claim 11, wherein the method further comprises controlling a shutter of the imaging device to capture another image based at least in part on the evaluation.

20-60. (cancelled)

61. A non-transitory computer-readable medium storing instructions that, when executed, cause a computer to perform a method comprising:
obtaining an image from an imaging device carried by an unmanned aerial vehicle (UAV), the imaging device being coupled to the UAV via a carrier that permits the imaging device to move relative to the UAV with respect to one or more axes;
obtaining one or more composition metrics;
evaluating a composition of the image using the one or more composition metrics; and
controlling the UAV or the carrier based at least in part on the evaluation.
